(19) United States
(12) Patent Application Publication
(10) Pub. No.: US 2026/0171492 A1
(43) Pub. Date: Jun. 18, 2026

(54) SOLID-STATE ELECTROLYTE INCLUDING A METAL-ORGANIC FRAMEWORK

(71) Applicants: King Fahd University of Petroleum and Minerals, Dhahran (SA); DAEGU GYEONGBUK INSTITUTE OF SCIENCE & TECHNOLOGY (DGIST), Daegu (KR)

(72) Inventors: Firoz KHAN, Dhahran (SA); Amir AL-AHMED, Dhahran (SA); Atif Saeed ALZAHRANI, Dhahran (SA); Jae Hyun KIM, Daegu (KR); Hasan JAMAL, Daegu (KR); Suin KIM, Daegu (KR); Sang-Eun CHUN, Daegu (KR)

(73) Assignees: King Fahd University of Petroleum and Minerals, Dhahran (SA); DAEGU GYEONGBUK INSTITUTE OF SCIENCE & TECHNOLOGY (DGIST), Daegu (KR)

(21) Appl. No.: 19/364,801

(22) Filed: Oct. 21, 2025

Related U.S. Application Data
(60) Provisional application No. 63/733,788, filed on Dec. 13, 2024.

(51) Int. Cl. H01M 10/0565; H01M 4/58; H01M 50/109

(52) U.S. Cl. CPC H01M 10/0565; H01M 4/5825; H01M 50/109; H01M 2300/0082

(57) ABSTRACT

A solid-state polymer electrolyte including, based on the weight of the electrolyte: from 60 to 75 wt. % of polyethylene oxide (PEO); from 20 to 30 wt. % of a lithium salt (Li⁺X⁻); and, from 1 to 20 wt. % of a zirconium (IV) benzene-1,3,5-tricarboxylate (BTC) metal-organic framework (MOF). The solid-state polymer electrolyte has an X-ray diffraction (XRD) pattern of MOF-808 and has the general formula Zr₆O₄(OH)₄(BTC)(L)₆, wherein L is an anion selected from the group consisting of fluoride, formate (COO⁻), acetate (CH₃COO⁻), propionate (CH₃CH₂COO⁻) and benzoate (C₆H₅COO⁻). The solid-state polymer electrolyte may have: an enthalpy of melting (ΔHₘ) of less than 50 Jg⁻¹; and, an ionic conductivity of at least 30 μScm⁻¹, as determined by electrochemical impedance spectroscopy (EIS) at 20° C.

### CROSS REFERENCE TO RELATED APPLICATION

The present application claims benefit of priority to U.S. Provisional Patent Application No. 63/733,788 having a filing date of Dec. 13, 2024 which is incorporated herein by reference in its entirety.

### STATEMENT OF PRIOR DISCLOSURE BY AN INVENTOR(S)

Aspects of the present disclosure are described in Suin Kim, Hasan Jamal, Firoz Khan, Amir Al-Ahmed, Mahmoud M. Abdelnaby, Atif Al-Zahrani, Sang-Eun Chun and Jae Hyun Kim, “Achieving high durability in all-solid-state lithium metal batteries using metal-organic framework solid polymer electrolytes,” J. Mater. Chem. A, 2024, 12, 10942-10955 which is incorporated herein by reference in its entirety.

### STATEMENT OF ACKNOWLEDGEMENT

Support provided by the National Research Foundation of Korea (NRF) and the Ministry of Science and ICT under grant numbers NRF-2018M3D1A1058728 and NRF-2021R1A2C1009736 is gratefully acknowledged.

### BACKGROUND

### Technical Field

The present disclosure is directed to a solid-state electrolyte and, more particularly, to a composite polymer electrolyte including a zirconium (IV) benzene-1,3,5-tricarboxylate (BTC) metal-organic framework (MOF).

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

The expanding electric vehicle market has caused a notable surge in demand for electrochemical energy storage devices. Whilst lithium-ion batteries (LIBs) with organic electrolytes are well-known such devices, these batteries present the risk of catching fire when overcharged and also experience dendrite-induced short circuits. In contrast, solid-sate electrolytes (SSEs) are more robust in terms of thermal, mechanical and chemical stability; in addition, SSEs can hinder or prevent the penetration of lithium dendrites. Consequently, SSEs are in high demand, thereby generating the important need to design materials which combine chemical and mechanical stability with sufficient lithium-ion conductivity.

Two main types of solid-sate electrolytes have been intensively studied for lithium-ion batteries, specifically inorganic/ceramic electrolytes and polymeric electrolytes. Inorganic/ceramic electrolytes typically require complex synthesis methods, tend to be stiff and fragile and can exhibit significant interfacial resistance. In contrast, polymer-based electrolytes—composed of a suitable lithium salt dispersed in a polymer matrix—demonstrate superior mechanical flexibility but, conversely, tend to have low room-temperature ionic conductivity, with exemplary conductivities below 10⁻⁶ siemens per centimeter (Scm⁻¹) being known.

Polyethylene oxide (PEO) has been often used in solid-sate electrolytes. The ionic conduction properties of PEO originate from its high polymer chain flexibility and the oxygen atoms in its backbone (ether-oxygen bond), which oxygen atoms can coordinate with lithium ions and can conduct those ions via the thermal motion of the chain segment. [See: Shen, R. et al. Enhancing Li⁺transport kinetics of PEO-based polymer electrolyte with mesoporous silica-derived fillers for lithium-ion batteries, Solid-state Ion. 354 (2020) 115412.] One disadvantage of PEO is its crystallization at ambient temperatures, which can lead to low ionic conductivity (σ) given that ionic conductivity is proportionally related to the extent of the amorphous regions of the polymer[See Z. Zhang et al. MOF-derived multifunctional filler reinforced polymer electrolyte for solid-state lithium batteries, J. Energy Chem. 60 (2021) 259-271.]; Preventing the unwanted crystallization PEO at room temperature can be critical to its functionality in SSEs.

The ionic conductivity (σ) of PEO can be moderated by the inclusion of plasticizers, copolymers or inorganic particles in the polymer matrix. Exemplary inorganic particles which have found utility in this regard include Li_{6.75}La₃Zr_{1.75}Ta_{0.25}O₁₂, Li_{0.33}La_{0.57}TiO₃, and Li_{1.3}Al_{0.3}Ti_{0.7}(PO₄)₃, as well as non-conductive materials, such as SiO₂, zeolites, Al₂O₃ and ZrO₂. [See: H. Jamal et al. Restraining lithium dendrite formation in all-solid-state Li-metal batteries via the surface modification of the ceramic filler, SM&T 35 (2023) e00548; H. Jamal et al. Enhanced compatibility of a polymer-based electrolyte with Li-metal for stable and dendrite-free all-solid-state Li-metal batteries, J. Mater. Chem. A. 9(48) (2021) 27304-27319; J. Zhang et al. High-voltage and free-standing poly(propylene carbonate)/Li_{6.75}La₃Zr_{1.75}Ta_{0.25}O₁₂ composite solid electrolyte for wide temperature range and flexible solid lithium ion battery, J. Mater. Chem. A. 5(10) (2017) 4940-4948; P. Zhu et al. Li_{0.33}La_{0.557}TiO₃ ceramic nanofiber-enhanced polyethylene oxide-based composite polymer electrolytes for all-solid-state lithium batteries, J. Mater. Chem. A. 6(10) (2018) 4279-4285.; L. Yang et al. Lithium-Ion Batteries: Flexible Composite Solid Electrolyte Facilitating Highly Stable “Soft Contacting” Li-Electrolyte Interface for Solid-state Lithium-Ion Batteries, Adv. Energy Mater. 7(22) (2017); D. Lin et al. High Ionic Conductivity of Composite Solid Polymer Electrolyte via In Situ Synthesis of Monodispersed SiO₂ Nanospheres in Poly(ethylene oxide), Nano Lett. 16(1) (2016) 459-465; and, W. Liu et al. Improved Lithium Ionic Conductivity in Composite Polymer Electrolytes with Oxide-Ion Conducting Nanowires, ACS Nano 10(12) (2016) 11407-11413.]

As an alternative to inorganic particulate fillers, metal-organic frameworks (MOFs) have also been studied as a means to control crystallization and improve the ionic conductivity of PEO. When MOFs—such as Zr (IV) MOFs (MOFs-808), MIL-100(Fe)-MOF and Ce-based nano-structured MOFs—are employed in solid electrolytes, their effective surface area and adjustable pore size enable the selective adsorption and storage of certain guest species, including gases, small molecules and ions, such as Li⁺ ions. More particularly, MOFs can be transformed into lithium-ion conductors by adsorbing compounds or mixtures containing Li within their pores. [See: L. Sun et al. Measuring and Reporting Electrical Conductivity in Metal-Organic Frameworks: Cd2(TTFTB) as a Case Study, J. Am. Chem. Soc. 138(44) (2016) 14772-14782; and, S. S. Park et al. Single-Ion Li⁺, Na⁺, and Mg²⁺Solid Electrolytes Supported by a Mesoporous Anionic Cu-Azolate Metal-Organic Framework, J. Am. Chem. Soc. 139(38) (2017) 13260-13263.]

However, the presence of redundant MOFs as fillers can create additional resistance to ion transport within the electrolyte. [See H. Huo et al. Anion-immobilized polymer electrolyte achieved by cationic metal-organic framework filler for dendrite-free solid-state batteries, Energy Stor. Mater. 18 (2019) 59-67.] Moreover, certain composite polymer electrolytes containing MOFs have demonstrated limited lifespans and poor cycling stability. [See: X. Wu et al. Metal organic framework reinforced polymer electrolyte with high cation transference number to enable dendrite-free solid-state Li metal conversion batteries, J. Power Sources 501 (2021) 229946; and, T. Wei et al. Activated metal-organic frameworks (a-MIL-100 (Fe)) as fillers in polymer electrolyte for high-performance all-solid-state lithium metal batteries, Mater. Today Commun. 31 (2022) 103518.]

Accordingly, one objective of the present disclosure is to explore a solid polymer electrolyte that supports high ion conductivity at room temperature and displays cycling stability and stability against oxidation. Further, there is a need for a solid polymer electrolyte which is thermally stable and is obtained via a facile and low-cost manufacturing process.

### SUMMARY

In an exemplary embodiment, a solid-state polymer electrolyte is described. The solid-state polymer electrolyte comprises, based on the weight of the electrolyte: from 60 to 75 weight percent (wt. %) of polyethylene oxide (PEO); from 20 to 30 weight percent (wt. %) of a lithium salt (Li⁺X⁻); and, from 1 to 20 wt. % of a zirconium (IV) benzene-1,3,5-tricarboxylate (BTC) metal-organic framework (MOF). The solid-state polymer electrolyte has an X-ray diffraction (XRD) pattern of MOF-808 and has the general formula Zr₆O₄(OH)₄(BTC)(L)₆, wherein L is a counter-anion.

In some embodiments, the solid-state polymer electrolyte has an enthalpy of melting (ΔHₘ) of less than about 50 joules per gram (Jg⁻¹), and an ionic conductivity of at least about 30 microsiemens per centimeter (μScm⁻¹), as determined by electrochemical impedance spectroscopy (EIS) at about 20 degrees Celsius (° C.).

The polyethylene oxide (PEO) is in the solid-state. In some embodiments, the polyethylene oxide (PEO) has a weight average molecular weight (Mw) of from about 100 to about 5000 kilodaltons (kDa).

In some embodiments, the molar ratio of the residues of ethylene oxide (EO) in the polyethylene oxide (PEO) to Li⁺ is from about 15:1 to about 20:1.

In some embodiments, the lithium salt is selected from the group consisting of: lithium p-toluenesulfonate, lithium methanesulfonate, lithium trifluoromethane sulfonate, lithium bis(fluorosulfonyl)imide, and lithium bis(trifluoromethylsulfonyl)imide (LiTFSI).

In some embodiments, the lithium salt is LiTFSI.

In some embodiments, the zirconium (IV) benzene-1,3,5-tricarboxylate (BTC) metal-organic framework (MOF) is present in an amount of from about 2 to about 10 wt. %, based on the weight of the electrolyte.

In some embodiments, the zirconium (IV) benzene-1,3,5-tricarboxylate (BTC) metal-organic framework (MOF) is present in an amount of from about 5 to about 10 wt. %, based on the weight of the electrolyte.

In some embodiments, the zirconium (IV) benzene-1,3,5-tricarboxylate (BTC) metal-organic framework (MOF) is present in an amount of about 7.5 wt. %, based on the weight of the electrolyte.

In some embodiments, L is selected from the group consisting of fluoride, formate (COO⁻), acetate (CH₃COO⁻), propionate (CH₃CH₂COO⁻) and benzoate (C₆H₅COO⁻).

In some embodiments, anion L is acetate.

In some embodiments, the solid-state polymer electrolyte has a Li⁺ ion transference number (t_{Li+}) of at least 0.5, as determined by direct current polarization at 60° C. and alternating current EIS.

In an exemplary embodiment, a method of making the solid-state polymer electrolyte is described. The method comprises: drying the polyethylene oxide (PEO) in a vacuum oven at a first temperature for a first duration; drying the lithium salt (Li⁺X⁻) and the zirconium (IV) benzene-1,3,5-tricarboxylate (BTC) metal-organic framework (MOF) in a vacuum oven at a second temperature for a second duration, and mixing the dried lithium salt and the dried zirconium (IV) benzene-1,3,5-tricarboxylate (BTC) metal-organic framework (MOF) in a first polar organic solvent to obtain a first mixture. The method further comprises mixing the dried PEO with the first mixture to obtain a second mixture, grinding the second mixture to obtain a first slurry, and evaporating the first polar organic solvent to obtain the solid-state polymer electrolyte.

In some embodiments, the first temperature is from about 40 to about 80° C., and the first duration is from about 6 to about 12 hours.

In some embodiments, the second temperature is from about 100 to about 140° C., and the second duration is from about 8 to about 16 hours.

In some embodiments, the first polar organic solvent includes at least one compound selected from the group consisting of dimethylformamide, diethylformamide, acetonitrile, methanol, ethanol, isopropanol, 1-butanol and acetone.

In some embodiments, the method further comprises: dispersing the solid-state polymer electrolyte, at least one active material capable of insertion and extraction of Li⁺ ions, a conductive carbon additive and a binder in a second polar organic solvent to obtain a third mixture; grinding the third mixture to obtain a second slurry; casting the second slurry onto an aluminium foil to obtain a casted slurry; drying the casted slurry in a conventional oven at a third temperature for a third duration to obtain a dried slurry; and, vacuum drying the dried slurry at a fourth temperature for a fourth duration to obtain a composite electrode.

In some embodiments: the at least one active material capable of insertion and extraction of Li⁺ ions is selected from the group consisting of lithium cobalt oxide (LiCoO₂), lithium manganese oxide (LiMn₂O₄), lithium iron phosphate (LiFePO₄) and lithium nickel manganese cobalt oxide (NMC); and, the conductive carbon additive is selected from the group consisting of carbon black, carbon fibers, carbon nanotubes, carbon nanostructures (CNS), graphene, fullerene, graphite, activated carbon and mixtures thereof.

In some embodiments, the at least one active material capable of insertion and extraction of Li⁺ ions comprises LiFePO₄, and the conductive carbon additive comprises carbon black and carbon nanotubes.

In some embodiments: the third temperature is from about 200 to about 350° C.; the third duration is from about 0.5 to about 12 hours; the fourth temperature is from about 200 to about 350° C.; and, the fourth duration is from about 0.5 to 12 hours.

In some embodiments, an all-solid-state lithium metal battery is described. The all-solid-state lithium metal battery comprises: an anode including lithium and being capable of insertion and extraction of Li⁺ ions; a cathode capable of insertion and extraction of Li⁺ ions; and, a solid-state electrolyte disposed between the anode and cathode and including the solid-state polymer electrolyte. The all-solid-state lithium metal battery is fabricated in a coin-cell structure.

In some embodiments, the cathode comprises at least one composite lithium metal oxide selected from the group consisting of LiCoO₂, LiMn₂O₄, LiFePO₄, and NMC.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A shows a method flowchart for making a solid-state polymer electrolyte, according to certain embodiments.

FIG. 1B shows a method flowchart for making a composite electrode, according to certain embodiments.

FIG. 2A shows an X-ray diffraction (XRD) pattern of zirconium-based metal-organic framework (MOF-808) with a molar ratio of Zr:benzene-1,3,5-tricarboxylic acid (BTC) of about 3:1 (ZR8), according to certain embodiments.

FIG. 2B shows a nitrogen (N₂) adsorption-desorption isotherms of ZR8, according to certain embodiments.

FIG. 2C shows a Barrett-Joyner-Halenda (BJH) plot for pore size distribution of ZR8, according to certain embodiments.

FIG. 2D shows a field emission scanning electron microscopy (FE-SEM) image of ZR8, according to certain embodiments.

FIG. 2E shows a Scanning Electron Microscopy (SEM)-energy dispersive X-ray (EDX) map of ZR8, according to certain embodiments.

FIG. 2F shows a SEM-EDX mapping image of ZR8 showing the presence of carbon (C), according to certain embodiments.

FIG. 2G shows a SEM-EDX mapping image of ZR8 showing the presence of oxygen (O), according to certain embodiments.

FIG. 2H shows a SEM-EDX mapping image of ZR8 showing the presence of zirconium (Zr), according to certain embodiments.

FIG. 2I shows a SEM-EDX mapping image of ZR8 showing the presence of chlorine (Cl), according to certain embodiments.

FIG. 3A shows a Scanning Electron Microscopic (SEM)-image of 2.5 wt. % of ZR8 (ZR8-2.5), based on the weight of the composite polymer electrolytes (CPE), according to certain embodiments.

FIG. 3B shows a SEM image of 5 wt. % of ZR8 (ZR8-5), based on the weight of the CPE, according to certain embodiments.

FIG. 3C shows a SEM image of 7.5 wt. % of ZR8 (ZR8-7.5), based on the weight of the CPE, according to certain embodiments.

FIG. 3D shows a SEM image of 10 wt. % of ZR8 (ZR8-10), based on the weight of the CPE, according to certain embodiments.

FIG. 4A shows a Filed-Emission Scanning Electron Microscopy (FE-SEM) image of ZR8-7.5 CPE, according to certain embodiments.

FIG. 4B shows a SEM-EDX map of ZR8-7.5 CPE, according to certain embodiments.

FIG. 4C shows a SEM-EDX mapping image of ZR8-7.5 CPE showing the presence of carbon (C), according to certain embodiments.

FIG. 4D shows a SEM-EDX mapping image of ZR8-7.5 CPE showing the presence of oxygen (O), according to certain embodiments.

FIG. 4E shows a SEM-EDX mapping image of ZR8-7.5 CPE showing the presence of nitrogen (N), according to certain embodiments.

FIG. 4F shows a SEM-EDX mapping image of ZR8-7.5 CPE showing the presence of sulfur (S), according to certain embodiments.

FIG. 4G shows a SEM-EDX mapping image of ZR8-7.5 CPE showing the presence of fluorine (F), according to certain embodiments.

FIG. 4H shows a SEM-EDX mapping image of ZR8-7.5 CPE showing the presence of zirconium (Zr), according to certain embodiments.

FIG. 4I shows a SEM-EDX mapping image of ZR8-7.5 CPE showing the presence of chlorine (Cl), according to certain embodiments.

FIG. 5A shows an optical image of ZR8-2.5 CPE, according to certain embodiments.

FIG. 5B shows an optical image of ZR8-5 CPE, according to certain embodiments.

FIG. 5C shows an optical image of ZR8-7.5 CPE, according to certain embodiments.

FIG. 5D shows an optical image of ZR8-10 CPE, according to certain embodiments.

FIG. 6 shows bending images of ZR8-7.5 CPE at various angles, according to certain embodiments.

FIG. 7 displays the thermal properties of SPE and ZR8-CPEs as determined by Differential Scanning Calorimetry (DSC), according to certain embodiments.

FIG. 8 provides thermogravimetric analysis (TGA) curves of a comparative solid polymer electrolyte (CCPE) and ZR8-2.5, ZR8-5, ZR8-7.5, and ZR8-10 CPEs, according to certain embodiments.

FIG. 9 shows curves of heat release rate (HRR) versus time for CCPE and ZR8-CPEs, according to certain embodiments.

FIG. 10A shows an image for a flame test of ZR8-2.5 CPE, according to certain embodiments.

FIG. 10B shows an image for a flame test of ZR8-5 CPE, according to certain embodiments.

FIG. 10C shows an image for a flame test of ZR8-7.5 CPE, according to certain embodiments.

FIG. 10D shows an image for a flame test of ZR8-10 CPE, according to certain embodiments.

FIG. 11 shows room temperature stress-strain curves of ZR8-CPEs with varying ZR8 content (from 2.5 to 10 wt. %) at a scan rate of 10 millimeter per minute (mm/min), according to certain embodiments.

FIG. 12A illustrates a Raman spectrum of SPE, according to certain embodiments.

FIG. 12B illustrates a Raman spectrum of ZR8-2.5, according to certain embodiments.

FIG. 12C illustrates a Raman spectrum of ZR8-5, according to certain embodiments.

FIG. 12D illustrates a Raman spectrum of ZR8-7.5, according to certain embodiments.

FIG. 12E illustrates a Raman spectrum of ZR8-10, according to certain embodiments.

FIG. 13A illustrates an electrochemical impedance spectrum (EIS) of ZR8-2.5 in the temperature range of 20-70° C., according to certain embodiments.

FIG. 13B illustrates an electrochemical impedance spectrum (EIS) of ZR8-5 in the temperature range of 20-70° C., according to certain embodiments.

FIG. 13C illustrates an electrochemical impedance spectrum (EIS) of ZR8-7.5 in the temperature range of 20-70° C., according to certain embodiments.

FIG. 13D illustrates an electrochemical impedance spectrum (EIS) of ZR8-10 in the temperature range of 20-70° C., according to certain embodiments.

FIG. 14 illustrates linear sweep voltammetry (LSV) curves for ZR8-2.5, ZR8-5, and ZR8-10 at 60° C., according to certain embodiments.

FIG. 15A shows a current-time profile for ZR8-2.5 CPE of coin cell [Li|ZR8-CPE|Li] as determined at 60° C. with a polarization voltage of 10 millivolts (mV) for 14400 seconds (s), according to certain embodiments.

FIG. 15B shows a current-time profile for ZR8-5 CPE of coin cell [Li|ZR8-CPE|Li] as determined at 60° C. with polarization voltage of 10 mV for 14400 s, according to certain embodiments.

FIG. 15C shows a current-time profile for ZR8-10 CPE of coin cell [Li|ZR8-CPE|Li] as determined at 60° C. with polarization voltage of 10 mV for 14400 s, according to certain embodiments.

FIG. 15D shows a comparison of lithium-ion transference number and ionic conductivity at 60° C. with previously published articles, according to certain embodiments.

FIG. 16A shows the electrochemical performance of Lithium-stripping cycling in a [Li|electrolyte|Li] coin cell as determined at different current densities of from 50-300 μAcm⁻² for 300 cycles at 60° C. for ZR8-2.5, according to certain embodiments.

FIG. 16B shows the electrochemical performance of Lithium-stripping cycling in a [Li|electrolyte|Li] coin cell as determined at different current densities of from 50-300 μAcm⁻² for 300 cycles at 60° C. for ZR8-5, according to certain embodiments.

FIG. 16C shows the electrochemical performance of Lithium-stripping cycling in a [Li|electrolyte|Li] coin cell as determined at different current densities of from 50-300 μAcm⁻² for 300 cycles at 60° C. for ZR8-10, according to certain embodiments.

FIG. 16D shows the rate capability of coin cells having the configuration [Li|ZR8-7.5|Li] and operated at 60° C., evaluated at different charge rates (C-rates), according to certain embodiments.

FIG. 16E is a real time image showing the practical utility of a coin cell based on ZR8-7.5 CPE for lighting a LED at room temperature, according to certain embodiments.

FIG. 16F is a real time image showing the practical utility of a coin cell based on ZR8-7.5 electrolyte for lighting a LED at 60° C., according to certain embodiments.

FIG. 16G is a real time image showing the ZR8-CPE coin cell with multimeter during the measurement of current at room temperature, according to certain embodiments.

FIG. 16H is a real time image showing the ZR8-CPE coin cell with multimeter during the measurement of voltage at room temperature, according to certain embodiments.

FIG. 17A shows a cycling performance of ZR8-2.5 for 800 cycles at 0.5 coulombs (C) using coin cell [Li|ZR8CPE|LFP] as determined at 60° C., according to certain embodiments.

FIG. 17B shows a cycling performance of ZR8-5 for 800 cycles at 0.5 C using coin cell [Li|ZR8CPE|LFP] as determined at 60° C., according to certain embodiments.

FIG. 17C shows a cycling performance of ZR8-7.5 for 800 cycles at 0.5 C using coin cell [Li|ZR8CPE|LFP] as determined at 60° C., according to certain embodiments.

FIG. 17D shows a cycling performance of ZR8-10 for 800 cycles at 0.5 C using coin cell [Li|ZR8CPE|LFP] as determined at 60° C., according to certain embodiments.

FIG. 17E shows cycling performance of ZR8-7.5 CPE for 100 cycles at 0.1 C using coin cell [Li|ZR8CPE|NCM811] as determined at 60° C., according to certain embodiments.

FIG. 18A shows a SEM image after cycling a [Li|ZR8-2.5|LFP] cell for 800 cycles, according to certain embodiments.

FIG. 18B shows a SEM image after cycling a [Li|ZR8-7.5|LFP] cell for 800 cycles, according to certain embodiments.

FIG. 19A shows the SEM image of ZR8-7.5 after 800 cycles, according to certain embodiments.

FIG. 19B shows the EDX elemental map of ZR8-7.5 after 800 cycles, according to certain embodiments.

FIG. 19C shows the EDX elemental mapping image of ZR8-7.5 after 800 cycles revealing the presence of oxygen (O), according to certain embodiments.

FIG. 19D shows the EDX elemental mapping image of ZR8-7.5 after 800 cycles revealing the presence of fluorine (F), according to certain embodiments.

FIG. 19E shows the EDX elemental mapping image of ZR8-7.5 after 800 cycles revealing the presence of zirconium (Zr), according to certain embodiments.

FIG. 19F shows the EDX elemental mapping image of ZR8-7.5 after 800 cycles revealing the presence of carbon (C), according to certain embodiments.

FIG. 19G shows the EDX elemental mapping image of ZR8-7.5 after 800 cycles revealing the presence of nitrogen (N), according to certain embodiments.

FIG. 19H shows the EDX elemental mapping image of ZR8-7.5 after 800 cycles revealing the presence of sulfur (S), according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all, embodiments of the disclosure are shown.

In the drawings, like reference numerals designate identical or corresponding parts throughout the several views. Further, as used herein, the words ‘a,’ ‘an’ and the like generally carry a meaning of ‘one or more,’ unless stated otherwise.

Furthermore, the terms ‘approximately,’ ‘approximate,’ ‘about,’ and similar terms generally refer to ranges that include the identified value within a margin of 20%, 10%, or preferably 5%, and any values therebetween.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

As used herein, the term ‘compound’ refers to a chemical entity, regardless of its phase-solid, liquid, or gaseous-as well as its state-crude mixture, purified, or isolated.

As used herein, the term ‘amount’ refers to the level or concentration of one or more reactants, catalysts, or materials present in a reaction mixture.

As used herein, the term ‘particle’ refers to a small object that acts as a whole unit with regard to its transport and properties.

Unless otherwise stated, the term ‘particle size’ refers to the largest axis of the particle. In the case of a generally spherical particle, the largest axis is the diameter.

The term ‘median volume particle size’ (Dv50), where used herein, refers to a particle size corresponding to 50% of the volume of the sampled particles being greater than and 50% of the volume of the sampled particles being smaller than the recited Dv50 value. Similarly, if used, the term ‘Dv90’ refers to a particle size corresponding to 90% of the volume of the sampled particles being smaller than and 10% of the volume of the sampled particles being greater than the recited Dv90 value. Particle size is determined herein by Scanning Electron Microscopy (SEM).

As used herein, the term ‘nanoparticles (NPs)’ refers to particles having a particle size of 1 nanometer (nm) to 500 nm within the scope of the present invention. The NPs may exist in various morphological shapes, such as nanotubes, nanowires, nanospheres, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, mixtures thereof and aggregates thereof.

As used herein, the term ‘porosity’ refers to a measure of the void or vacant spaces within a material.

As used herein, the term ‘pore diameter’ may be thought of as the length or longest dimension of a pore opening.

As used herein, the term ‘pore volume’ refers to the total volume of the empty spaces, or pores, within a material.

As used herein, the term ‘room temperature’ refers to a temperature range of '23 degrees Celsius (° C.)±2° C. in the present disclosure. As used herein, ‘ambient conditions’ means the temperature and pressure of the surroundings in which the substance, composition or article is located.

The temperature parameters in the present application, if not specifically limited, are both allowed to be constant temperature processing and also allowed to be varied within a certain temperature interval. It should be understood that the constant temperature processing allows the temperature to fluctuate within the precision range of the instrument control. It is allowed to fluctuate in the range of, for example, 5° C., 4° C., 3° C., 2° C., or 1° C.

As used herein, the term ‘fraction’ refers to a numerical quantity which defines a part up to but not including 100 percent or the entirety of the thing in question.

As used herein the term ‘disposed’ refers to being positioned, placed, deposited, arranged or distributed in a particular manner.

The term “dry” as used herein means comprising less than 5 wt. % of any compound or composition being in liquid form when measured at 25° C. under ambient conditions. For instance, the term “dry” includes comprising less than 3 wt. %, less than 2 wt. %, less than 1%, or even about 0% of said compound or composition being in liquid form when measured at 25° C. under ambient conditions. Exemplary such compounds or compositions include water, oils, organic solvents and other wetting agents.

As used herein, the term ‘vacuum drying’ refers to drying which is performed under reduced pressure, such as a pressure less than 0.1 megapascal (MPa). The mixture to be dried is subjected to said reduced pressure at a temperature greater than the freezing point of the liquid to be removed under drying but less than the boiling point of that liquid.

As used herein, the term number average molecular weight (Mn) and weight average molecular weight (Mw) are determined by gel permeation chromatography (GPC) with tetrahydrofuran (THF) as the eluent in accordance with DIN 55672-1:2007-08.

As used herein, the term ‘X-ray diffraction’ or ‘XRD’ or ‘X-ray crystallography’ refers to basic technique for obtaining information on the atomic structure of crystalline materials used as a standard laboratory technique. Unless otherwise specified, the XRD shall include an analytical technique based on the diffraction of X-rays by matter, especially for crystalline materials.

As used herein, the term “average crystallite size” refers to the mean size of the crystalline domains or particles within a material. It is typically determined using X-ray diffraction (XRD) analysis, where the broadening of diffraction peaks is related to the size of the crystallites. The average crystallite size provides insight into the degree of crystallinity and the structural characteristics of the material. It is commonly expressed in nanometers (nm) and reflects the typical dimensions of the crystalline regions in the material, excluding any amorphous regions or defects.

As used herein, the term “atomic concentration” refers to the proportion or percentage of a specific element in a material, calculated based on the number of atoms of that element relative to the total number of atoms present in the material. It is typically expressed as a percentage (%) or as an atomic fraction. This measurement may be determined using the exemplary techniques of X-ray fluorescence (XRF), energy-dispersive X-ray spectroscopy (EDX), or inductively coupled plasma mass spectrometry (ICP-MS). Where stated herein, atomic concentration is determined using energy-dispersive X-ray spectroscopy (EDX).

As used herein, the term ‘Scanning Electron Microscopy’ or ‘SEM’ refers to a surface-imaging technique that produces images of a sample by scanning the sample with a focused beam of electrons. Unless otherwise specified, the SEM shall include all imaging techniques using electron beams for imaging.

Where mentioned, a calculated glass transition temperature (‘T_{g}’) of a polymer or co-polymer is that temperature which may be calculated by using the Fox equation (T. G. Fox, Bull. Am. Physics Soc., Volume 1, Issue No. 3, page 123(1956), the disclosure of which is herein incorporated by reference in its entirety).

The measured glass transition temperature (T_{g}) of a material is determined herein by differential scanning calorimetry (DSC) in accordance with the methodology of Deutsches Institut für Normung (DIN) 11357.

As used herein, the term ‘softening point’ refers to the temperature at which a material, such as a polymer, loses its solid characteristics and becomes relatively fluid. A material's softening point as given herein is that temperature measured using the standard ball and ring method according to ISO 4625-1: 2004.

As used herein, the term ‘electrically conductive’ as used herein references materials, such as fillers, which have a bulk resistivity of less than 10 ohm-cm, in particular less than 1.0 ohm-cm or less than 0.1 ohm-cm.

As used herein, the term ‘cell’ refers to an electrochemical device used for generating a voltage or current from an electrochemical reaction, or the reverse in which an electrochemical reaction is induced by a current. Examples include voltaic cells, electrolytic cells, redox flow cells, and fuel cells, among others. A battery includes one or more cells. The terms ‘cell’ and ‘battery’ are used interchangeably only when referring to a battery containing a single cell.

As used herein, the term ‘coin cell’ refers to a small, typically circular-shaped, or button-like, battery. Coin cells are characterized by their diameter and thickness. For example, a type 2325 coin cell has a diameter of 23 millimeter (mm) and a height of 2.5 mm.

As used herein, the term ‘electrode’ refers to an electrical conductor used to contact a non-metallic part of a circuit, such as a semiconductor, an electrolyte, a vacuum, or air.

As used herein, the term ‘specific capacity’ refers to capacity per unit of mass. Specific capacity may be expressed in units of milliampere hours per gram (mAh/g).

As used herein, the term ‘electrolyte’ is used in accordance with its standard meaning in the art as a substance containing free ions which can conduct electricity by displacement of charged carrier species. In a solid electrolyte, at least one of the cationic or anionic components of the electrolyte structure is essentially free for displacement, thus acting as charge carrier.

As used herein, the term ‘solid-state polymers’ refers to polymer materials that can conduct ions and exist in a solid-state. These are frequently utilized in solid-state batteries and other energy storage devices.

As used herein, the term ‘solid-state polymer electrolyte’ refers to solid-state polymer substance used in electrochemical systems such as fuel cells and batteries that transmits ions.

As used herein, the term ‘anode’ refers to an electrode of a polarized electrical device through which the conventional current enters the device.

As used herein, the term ‘cathode’ refers to an electrode of the device through which conventional current leaves the device.

As used herein, a ‘voltammogram’ refers to a graphical representation of current versus voltage, typically obtained during cyclic voltammetry, used to analyze the electrochemical behavior of materials.

As used herein, the term ‘current density’ refers to the amount of electric current traveling per unit cross-section area.

As used herein, the term ‘energy density’ refers to the amount of energy stored in a supercapacitor per unit volume of supercapacitor.

As used herein, the term ‘power density’ refers to the measure of power output per unit volume.

As used herein, the term ‘intercalation’ refers to the insertion of a material (for instance an ion, molecule or group) between the atoms, molecules, or groups of another material. For example, lithium-ions can insert, or intercalate, into graphite (C) to form lithiated graphite (LiC₆).

As used herein, the term ‘inert gas’ refers to a gas that is chemically non-reactive under the conditions of use. These gases have a stable electron configuration and do not readily form compounds with other elements or molecules. Inert gases are often used in various processes to create an environment that prevents unwanted chemical reactions, such as oxidation or combustion. Common examples of inert gases include helium, argon, neon, krypton, xenon, and nitrogen.

As used herein, the term ‘polar solvent’ refers to a solvent having a dielectric constant (s) of more than 5 as measured at 25° C. The determination of dielectric constant (s) is known in the art: the use of measured voltages across parallel plate capacitors in such determinations may be mentioned. The term ‘polar solvent’ may encompass both aprotic and protic solvents, wherein protic solvents are those solvents which are capable of yielding or accepting a proton and aprotic solvents are those solvents that do not yield or accept a proton.

As used herein, the term ‘ionic conductivity’ refers to the ability of a material to conduct ions.

As used herein, the term ‘fiber’ refers to an elongate particulate having an apparent length which exceeds its apparent diameter. The fiber may be characterized by its ‘aspect ratio’ which describes the proportional relationship between the length of the fiber and its diameter. The fibers having utility herein may have any configuration known in the art: for example, the configuration of the fibers may be circular, ovular, elliptical or flat. As regards fibers which possess a non-circular cross-section, the diameter thereof is considered to be the diameter of a circle having a cross-sectional area equal to the cross-sectional area of the fiber.

As used herein, the term ‘carbon fiber’ refers to a fiber of which carbon constitutes at least 95 wt. %, based on the weight of the fiber.

As regards the disposition of fibers, the term ‘woven’ refers to an interlacing of individual fibers in a regular order. Conversely, a ‘nonwoven fibrous web’ refers to a web having a structure of individual fibers which are interlaid, but not in an identifiable order. The non-woven fibrous web will typically include non-parallel, randomly oriented fibers.

As used herein, the term ‘fibrous tape’ refers to a narrow strip of fibrous material. Tapes generally have a flat structure with a substantially rectangular cross-section. The fibrous tapes having utility herein will typically have: a thickness—as measured at the thickest region of the cross-section—of from 0.1 to 500 micrometer (μm), for example from 0.5 to 250 μm or from 0.5 to 100 μm; a width of less than or equal to 15 centimeter (cm), for example of from 0.1 to 5 cm; and, an average cross-sectional aspect ratio—defined as the ratio of the greatest to the smallest dimension of cross-sections averaged over the length of the tape article—of at least 3. The cross-sectional aspect ratio of the fibrous tapes may be, for example, at least 20, at least 50 or even at least 100.

As used herein, the term ‘carbon nanotube’ refers to carbon fullerene, a synthetic graphite, which typically has a molecular weight of greater than 840 g/mole. The term is intended to encompass roped carbon nanotubes, single-walled carbon nanotubes (SWCNT) and multiple walled carbon nanotubes (MWCNT). Single walled carbon nanotubes—having a wall consisting of only one graphene layer—typically have diameters of from 1 to 5 nm; multi-walled carbon nanotubes typically have diameters of from 5 to 200 nm. It is further envisaged that carbon nanotubes having utility herein may be opened or chopped. And still further, the present disclosure does not preclude the use of carbon nanotubes which have been chemically modified through, for example, doping with thionyl chloride (SOCl₂).

As used herein, the term ‘carbon nanostructure’ or ‘CNS’ refers to a plurality of CNTs that can exist as a polymeric structure through, in particular, sharing common walls with one another and/or through being one or more of: interdigitated; branched; entangled; or, crosslinked. Thus, carbon nanostructures can be considered to have carbon nanotubes as a base monomer unit of their polymeric structure. In many cases, the constituent carbon nanotubes will be multiple walled carbon nanotubes (MWCNT).

As used herein ‘metal-organic frameworks or MOFs’ refers to compounds having a lattice structure made from (i) a cluster of metal ions as vertices (‘cornerstones’) (‘secondary building units’ or SBUs) which are metal-based inorganic groups, for example metal oxides and/or hydroxides, linked together by (ii) organic linkers. The linkers are usually at least bidentate ligands which coordinate to the metal-based inorganic groups via functional groups such as carboxylates and/or amines. MOFs are considered coordination polymers made up of (i) the metal ion clusters and (ii) linker building blocks.

As used herein, the term ‘C₁-Cₙ alkyl’ group refers to a monovalent group that contains 1 to n carbons atoms, that is a radical of an alkane and includes straight-chain and branched organic groups. As such, a ‘C₁-C₄ alkyl’ group refers to a monovalent group that contains from 1 to 4 carbons atoms, that is a radical of an alkane and includes straight-chain and branched organic groups. Examples of alkyl groups include, but are not limited to: methyl; ethyl; propyl; isopropyl; n-butyl; isobutyl; sec-butyl; and, tert-butyl. In the present invention, such alkyl groups may be unsubstituted or may be substituted with one or more halogen. Where applicable for a given moiety (R), a tolerance for one or more non-halogen substituents within an alkyl group will be noted in the specification.

As used herein, the term ‘alkylene group’ refers to a divalent radical divalent radical derived from an alkyl group, as defined above.

As used herein, the term ‘C₃-C₁₈ cycloalkyl’ refers to a saturated cyclic hydrocarbon having from 3 to 18 carbon atoms. In the present invention, such cycloalkyl groups may be unsubstituted or may be substituted with one or more halogen. Where applicable for a given moiety (R), a tolerance for one or more non-halogen substituents within a cycloalkyl group will be noted in the specification. Exemplary cycloalkyl groups include cyclopropyl, cyclobutyl, cyclopentyl or cyclohexyl groups.

As used herein, an ‘C₆-C₁₈ aryl’ group used alone or as part of a larger moiety—as in ‘aralkyl group’—refers to monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. In the present disclosure, such aryl groups may be unsubstituted or may be substituted with one or more halogen. Where applicable for a given moiety (R), a tolerance for one or more non-halogen substituents within an aryl group will be noted in the specification. Exemplary aryl groups include: phenyl; (C₁-C₄)alkylphenyl, such as tolyl and ethylphenyl; indenyl; naphthalenyl, tetrahydronaphthyl, tetrahydroindenyl; tetrahydroanthracenyl; and, anthracenyl.

As used herein, the term ‘alkylaryl’ refers to alkyl-substituted aryl groups as set forth above. Moreover, as used herein ‘aralkyl’ means an alkyl group substituted with an aryl radical as defined above.

As used herein, the term ‘hetero’ refers to groups or moieties containing one or more heteroatoms, such as N, O, Si and S. Thus, for example ‘heterocyclic’ refers to cyclic groups having, for example, N, O, Si or S as part of the ring structure. ‘Heteroalkyl’, ‘heterocycloalkyl’, ‘heteroaryl’ and ‘heteroalkylaryl’ moieties are alkyl, cycloalkyl and aryl groups as defined hereinabove, respectively, containing N, O, Si or S as part of their structure.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium, and isotopes of carbon include ¹³C and ¹⁴C. Isotopes of oxygen include ¹⁶O, ¹⁷O, and ¹⁸O. Isotopes of naturally occurring nickel ²⁸Ni include ⁵⁸Ni, ⁶⁰Ni, ⁶¹Ni, ⁶²Ni, and ⁶⁴Ni. Isotopes of cobalt (Co) are ⁵⁶Co, ⁵⁷Co, ⁵⁸Co, and ⁶⁰Co. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed toward solid-state composite polymer electrolytes with increased electrochemical stability and durability. The solid-state polymer electrolyte was prepared by incorporating highly porous Zr-based metal-organic frameworks (MOFs), as fillers in polyethylene oxide (PEO)/lithium-salt systems. The study findings demonstrated the potential of composite polymer electrolytes in solid-state lithium metal batteries and offer insightful information for choosing MOFs to alter all-solid electrolytes.

A solid-state polymer electrolyte is described. The solid-state polymer electrolyte includes: PEO; a lithium salt (Li⁺X⁻); and, a Zr (IV) benzene-1,3,5-tricarboxylate (BTC) MOF (ZR8). PEO has been often used as solid-sate electrolytes. The ionic conduction properties of polyethylene oxide originate from its high polymer chain flexibility and the oxygen atoms in its backbone (ether-oxygen bond), which oxygen atoms can coordinate with lithium-ions and can conduct those ions by the thermal motion of the chain segment. [See: Shen, R. et al. Enhancing Li⁺transport kinetics of PEO-based polymer electrolyte with mesoporous silica-derived fillers for lithium-ion batteries, Solid-state Ion. 354 (2020) 115412, the disclosure of which is incorporated herein by reference in its entirety.]

MOFs include a structure of metal nodes interconnected by organic linkers to thereby define a network of pores. These nano-sized porous materials with suitable ligands can offer a favorable environment to host diverse guest species. The precisely shaped pores of metal-organic frameworks enable the effective capture and confinement of guest molecules or ions within the structures. With their high ionic conductivity and high specific surface area, these organometallic compounds can function as excellent additives for composite polymer electrolyte. Moreover, metal-organic frameworks are lightweight, which enables higher filler loading without adding significant weight to the electrolyte. Furthermore, MOFs can be modified with suitable functional groups to regulate their surface polarity and to selectively tether anions in solid polymer electrolytes: this may enable anion adsorption and trapping such that the solid polymer electrolytes may be characterized by a high Li-ion transference number (t_{Li+}).

The solid-state polymer electrolyte comprises, based on the weight of the electrolyte: from about 60-75 wt. % of PEO, for example about 61-74 wt. %, about 62-73 wt. %, about 63-72 wt. %, about 64-71 wt. %, about 65-70 wt. %, about 66-69 wt. %, and about 67-68 wt. % of PEO, from 20-30 wt. % of a Li⁺X⁻, about 21-29 wt. %, about 22-28 wt. %, about 23-27 wt. %, or about 24-26 wt. % of Li⁺X⁻; and, from about 1-20 wt. % of a Zr (IV) BTC MOF, for example about 2-19 wt. %, about 3-18 wt. %, about 4-17 wt. %, about 5-16 wt. %, about 6-15 wt. %, about 7-14 wt. %, about 8-13 wt. %, about 9-12 wt. %, or about 10-11 wt. % of a Zr (IV) BTC MOF.

In some embodiments, the Zr (IV) BTC MOF is present in an amount of from about 2-10 wt. %, for example about 3-9 wt. %, about 4-8 wt. %, or about 5-7 wt. %, based on the weight of the electrolyte. In some embodiments, the Zr (IV) BTC MOF is present in an amount of from about 5-10 wt. %, preferably 6-9 wt. %, or preferably 7-8 wt. %, based on the weight of the electrolyte.

In a preferred embodiment, the Zr (IV) BTC MOF is present in an amount of about 7.5 wt. %, based on the weight of the electrolyte.

The PEO of the solid-state polymer electrolyte is itself a solid at 25° C. More particularly, the PEO should have a melting point of at least about 50° C., for example at least about 55° C. or at least about 60° C.

Subject the PEO being in the solid state, the PEO may in some embodiments have a weight average molecular weight (Mw) of about 100-5000 kilodaltons (kDa), for example about 200-4900 kDa, about 300-4800 kDa, about 400-4700 kDa, about 500-4600 kDa, about 600-4500 kDa, about 700-4400 kDa, about 800-4300 kDa, about 900-4200 kDa, about 1000-4100 kDa, about 1100-4000 kDa, about 1200-3900 kDa, about 1300-3800 kDa, about 1400-3700 kDa, about 1500-3600 kDa, about 1600-3500 kDa, about 1700-3400 kDa, about 1800-3300 kDa, about 1900-3200 kDa, about 2000-3100 kDa, about 2100-3000 kDa, about 2200-2900 kDa, about 2300-2800 kDa, about 2400-2700 kDa, or about 2500-2600 kDa.

Independently of, or additional to the aforementioned weight average molecular weight, in some embodiments, the molar ratio of the residues of EO in the PEO to Li⁺ is from about 15:1-20:1, about 16:1-19:1, or about 17:1-18:1.

In some embodiments, the lithium salt is selected from the group consisting of lithium p-toluenesulfonate, lithium methanesulfonate, lithium trifluoromethane sulfonate, lithium bis(fluorosulfonyl)imide, and lithium bis(trifluoromethylsulfonyl)imide. In a preferred embodiment, the lithium salt comprises or consists of lithium bis(trifluorosulfonyl)imide.

The solid-state polymer electrolyte demonstrates the X-ray diffraction (XRD) pattern of MOF-808 and has the general formula Zr₆O₄(OH)₄(BTC)(L)₆, wherein L is a counter anion. In some embodiments, L is an anion selected from the group consisting of fluoride, formate (COO⁻), acetate (CH₃COO⁻), propionate (CH₃CH₂COO⁻) and benzoate (C₆H₅COO⁻). In a preferred embodiment, L is acetate.

In some embodiments, the solid-state polymer electrolyte has an enthalpy of melting (ΔHₘ) of less than about 50 joules per gram (Jg⁻¹), for example less than about 49 Jg⁻¹, less than about 48 Jg⁻¹, less than about 47 Jg⁻¹, less than about 46 Jg⁻¹, less than about 45 Jg⁻¹, less than about 44 Jg⁻¹, less than about 43 Jg⁻¹, ess than about 42 Jg⁻¹, less than about 41 Jg⁻¹, less than about 40 Jg⁻¹, less than about 39 Jg⁻¹, less than about 38 Jg⁻¹, less than about 37 Jg⁻¹, less than about 36 Jg⁻¹, less than about 35 Jg⁻¹, less than about 34 Jg⁻¹, ess than about 33 Jg⁻¹, less than about 32 Jg⁻¹, less than about 31 Jg⁻¹, less than about 30 Jg⁻¹, or less than about 25 Jg⁻¹, In some embodiments, which are not mutually exclusive of those mentioned above, the solid-state polymer electrolyte has an ionic conductivity of at least about 30 microsiemens per centimeter (μScm⁻¹), for example at least about 40 μScm⁻¹, at least about 50 μScm⁻¹, at least about 60 μScm⁻¹, at least about 70 μScm⁻¹, at least about 80 μScm⁻¹, at least about 90 μScm⁻¹, at least about 100 μScm⁻¹, at least about 110 μScm⁻¹, or at least about 120 μScm⁻¹, as determined by electrochemical impedance spectroscopy (EIS) at about 20 degrees Celsius (° C.).

In some embodiments, the solid-state polymer electrolyte has a Li⁺ ion transference number (t_{Li+}) of at least about 0.5, for example at least about 0.51, at least about 0.52, at least about 0.53, at least about 0.54, at least about 0.55, at least about 0.56, at least about 0.57, at least about 0.58, at least about 0.59, at least about 0.6, at least about 0.61, at least about 0.62, at least about 0.63, at least about 0.64, at least about 0.65, at least about 0.66, at least about 0.67, at least about 0.68, at least about 0.69, or at least about 0.7, as determined by direct current polarization at 60° C. and alternating current EIS.

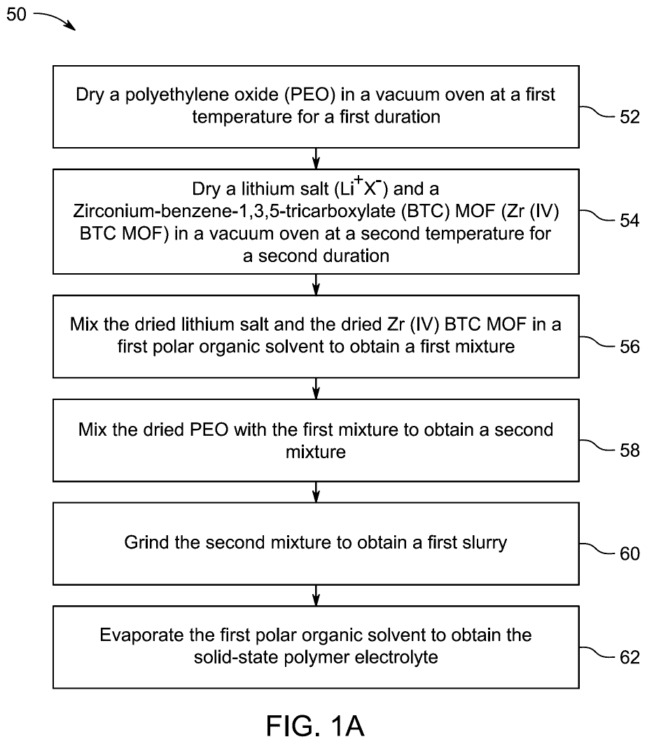

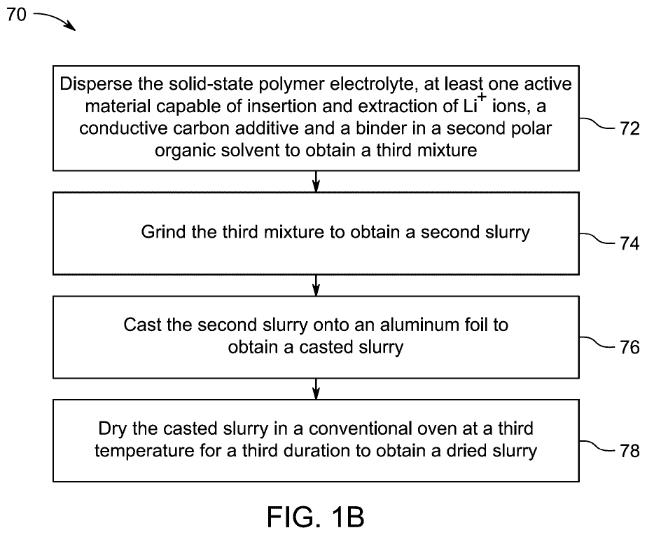

FIG. 1A illustrates a flow chart of a method 50 of making the solid-state polymer electrolyte. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes drying the polyethylene oxide (PEO) in a vacuum oven at a first temperature for a first duration. In some embodiments, the first temperature is from about 40-80° C., for example about 41-79° C., about 42-78° C., about 43-77° C., about 44-76° C., about 45-75° C., about 46-74° C., about 47-73° C., about 48-72° C., about 49-71° C., about 50-70° C., about 51-69° C., about 52-68° C., about 53-67° C., about 54-66° C., about 55-65° C., about 56-64° C., about 57-63° C., about 58-62° C., or about 59-61° C. Independently of, or additional to the selected first temperature, the first duration may, in certain embodiments, be from about 6 hours (h)-12 h, for example about 7-11 h, or about 8-10 h.

At step 54, the method 50 includes drying the lithium salt (Li⁺X⁻) and the Zr (IV) BTC MOF in a vacuum oven at a second temperature for a second duration. In some embodiments, the second temperature is from about 100-140° C., and the second duration is from about 8-16 h, for example about 9-15 h, about 10-14 h, or about 11-13 h.

At step 56, the method 50 includes mixing the dried lithium salt and the dried Zr (IV) BTC MOF in a first polar organic solvent to obtain a first mixture. Suitable examples of polar organic solvents include methanol, ethanol, acetone, dimethyl sulfoxide (DMSO), dimethylformamide, dimethylacetamide, iso-propanol and mixtures thereof. In some embodiments, the first polar organic solvent includes at least one compound selected from the group consisting of dimethylformamide, diethylformamide, acetonitrile, methanol, ethanol, isopropanol, 1-butanol and acetone. Alternative examples of polar organic solvents include, but are not limited to, dimethyl sulfoxide (DMSO), dimethylacetamide (DMA), acetaldehyde, ethyl acetate, methyl ethyl ketone (MEK), tetrahydrofuran (THF), propylene carbonate, N-methyl-2-pyrrolidone (NMP), 1,4-dioxane, formamide, glycol ethers, and mixtures thereof. The mixing may be carried out manually or with the help of a stirrer.

At step 58, the method 50 includes mixing the dried PEO with the first mixture to obtain a second mixture. The dried PEO may be mixed with the first mixture manually or with the help of a stirrer.

At step 60, the method 50 includes grinding the second mixture to obtain a first slurry. The grinding may be carried out using any suitable means, for example, ball milling, blending, etc., using a manual method (e.g., mortar) or a machine-assisted method such as using a mechanical blender, or any other apparatus known to those of ordinary skill in the art. Grinding provides efficient and consistent particle size reduction and helps in obtaining a uniform slurry.

At step 62, the method 50 includes evaporating the first polar organic solvent to obtain the solid-state polymer electrolyte. When the initial polar organic solvent is evaporated, the solvent is eliminated from the mixture, leaving behind a solid-state polymer electrolyte that is more stable and has improved ionic conductivity for use in electrochemical processes.

As described throughout this disclosure, the solid polymer electrolyte according to various embodiments and aspects described herein may have utility where metal ion conductivity and low electrical conductivity is required. Therefore, the solid polymer electrolyte may be useful as one or more components of an electrode composition.

In an embodiment, the present disclosure provides a composite electrode for a lithium-ion battery, said composite electrode comprising: at least one active material capable of insertion and extraction of Li⁺ ions; the solid polymer electrolyte of any of the embodiments and aspects described herein; a binder; and, at least one carbon conductive additive.

FIG. 1B illustrates a flow chart of a method 70 of making the composite electrode. The order in which the method 70 is described is not intended to be construed as a limitation, and any number of the described method steps can be combined in any order to implement the method 70.

Additionally, individual steps may be removed or skipped from the method 70 without departing from the spirit and scope of the present disclosure.

At step 72, the method 70 includes dispersing the solid-state polymer electrolyte, at least one active material capable of insertion and extraction of Li⁺ ions, a conductive carbon additive and a binder in a second polar organic solvent to obtain a third mixture (M^{E}).

The composite electrode may comprise, based on the weight of the composite electrode: from about 5-20 wt. %, for example about 6-19 wt. %, about 7-18 wt. %, about 8-17 wt. %, about 9-16 wt. %, about 10-15 wt. %, about 11-14 wt. %, or about 12-13 wt. % of the solid polymer electrolyte.

Typically, the polar organic solvent has a boiling point of at least about 20° C., for instance at least about 40° C. or at least about 50° C., as measured at 1 atmosphere pressure (0.1 MPa).

Examples of organic compounds, which may be used alone or in combination as the polar organic solvent, include: C₁-C₈ alkanols, such as methanol, ethanol, n-propanol, isopropanol, n-butanol, sec-butanol and isobutanol; N-formyl morpholine; N-acetyl morpholine; acetonitrile; N,N-di(C₁-C₄)alkylacylamides, such as N,N-dimethylformamide, N,N-diethylformamide, N,N-dimethylacetamide (DMAc) and 3-methoxy N,N′-dimethylpropanamide (MDP); hexamethylphosphoramide; NMP; N-ethyl-2-pyrrolidone (NEP); N-butyl-2-pyrrolidone (NBP); pyridine; esters, such as (C₁-C₈) alkyl acetates, ethoxydiglycol acetate, dimethyl glutarate, dimethyl maleate, dipropyl oxalate, ethyl lactate, benzyl benzoate, butyloctyl benzoate and ethylhexyl benzoate; ketones, such as acetone, ethyl ketone, methyl ethyl ketone (2-butanone) and methyl isobutyl ketone, cyclohexanone and methylcyclohexanone; γ-butyrolactone; ethers, such as THF, 2-methyltetrahydrofuran (2-MeTHF) and 1,2-dimethoxyethane; 1,3-dioxolane; DMSO; and, dichloromethane (DCM).

The polar organic solvent is preferably aprotic. More preferably, the polar organic solvent is selected from the group consisting of: γ-butyrolactone; cyclohexanone; methylcyclohexanone; NMP; NEP; NBP; N,N-dimethylacetamide; N-formyl morpholine; N-acetyl morpholine; MDP; and, mixtures thereof. In an embodiment, the polar organic solvent comprises or consists of NMP.

Suitable techniques for dispersion include, but not limited to, mechanical mixing, ultrasonication, high shear mixing, solvent evaporation, electrostatic dispersion, centrifugal dispersion. In the first step, the above-mentioned constituents are brought together and mixed. It is important that the mixing homogenously distributes the solid-state polymer electrolyte and the at least one active material within the composition: such thorough and effective mixing can be determinative of a homogeneous distribution of these constituents within the binder matrix of the resultant electrode and thereby of the provision of sufficient ionic conductivity to support an electrochemical reaction at the interface(s) of the electrode. To achieve such homogeneity, it is preferred that the constituents are not mixed by hand but are instead mixed by machine—a static or dynamic mixer, for example—in pre-determined amounts. A multi-stage mixing process may be appropriate in certain circumstances.

In some embodiments, the at least one active material capable of insertion and extraction of Li⁺ ions is selected from the group consisting of lithium cobalt oxide (LiCoO₂), lithium manganese oxide (LiMn₂O₄), lithium iron phosphate (LiFePO₄) and lithium nickel manganese cobalt oxide (NMC). In a preferred embodiment, the at least one active material capable of insertion and extraction of Li⁺ ions comprises or consists of LiFePO₄.

The composite electrode may comprise, based on the weight of the composite electrode, from about 50-80 wt. %, for example about 51-79 wt. %, about 52-78 wt. %, about 53-77 wt. %, about 54-76 wt. %, about 55-75 wt. %, about 56-74 wt. %, about 57-73 wt. %, about 58-72 wt. %, about 59-71 wt. %, about 60-70 wt. %, about 61-69 wt. %, about 62-68 wt. %, about 63-67 wt. %, about 64-66 wt. %, or about 65 wt. %, of the at least one active material capable of insertion and extraction of Li⁺ ions.

The disposal of the carbon conductive additive(s) in the composite electrode should form semi-continuous or continuous conductive pathways which extend through the body of the composite. These pathways should thereby provide a low resistance route by which electrons and, in some instances thermal phonons, can travel through the composite. It is preferred for the composite electrode to be electrically conductive in all three dimensions and thus across its width, length and thickness. As is known in the art, electrical resistance measurements may be taken on a surface of the composite material using a probe, such as a 4-point probe, connected to an ohmmeter.

The necessary formation of these conductive pathways should be determinative of the loading of the carbon conductive additive within the composite electrode. In addition, the loading of the carbon conductive additive may be selected to attain an operable density and operable mechanical properties of the composite material.

In certain embodiments, the composite electrode may comprise, based on the weight of the composite electrode, from about 0.5 to about 20 wt. % of carbon conductive additive, wherein the carbon conductive additive is characterized by a bulk resistivity of less than about 50 microohm-centimeters (μΩ-cm). For example, the composite material may include, based on the weight of the electrode, from about 5 to about 20 wt. %, for example about 5 to about 15 wt. % of said carbon conductive additive.

In an alternate expression which is not intended to be mutually exclusive of that given above, the composite electrode may comprise, based on the volume of the electrode, from about 5 to about 30 vol. % of carbon conductive additive, wherein said carbon conductive additive is characterized by a bulk resistivity of less than 50 microohm-centimeters (μΩ-cm). For example, the composite electrode may comprise, based on the volume of the electrode, from about 10 to about 25 vol. %, preferably from about 5 to about 20 vol. % of said carbon conductive additive.

The distribution of the carbon conductive additive within the binder matrix may be homogeneous or non-homogeneous. In certain situations, it may be beneficial for the concentration of carbon conductive additive to vary across a dimension, in the particular the thickness, of the composite electrode. The variation may permit specific loci of the composite electrode to exhibit higher relative electrical conductivity and, potentially, thermal conductivity. Such variation should not however compromise the structural integrity of the composite electrode by, for instance, reducing hardness, tensile strength or impact resistance of the composite electrode.

In some embodiments, the conductive carbon additive is selected from the group including carbon black, carbon fibers, CNTs, carbon nanostructures (CNS), graphene, fullerene, graphite, activated carbon and mixtures thereof. In a preferred embodiment, the conductive carbon additive comprises carbon black and/or CNTs.

The use of conductive carbon blacks as at least a portion of the conductive carbon additives is of particular interest. Said carbon blacks should desirably be characterized by: a specific surface area of from 20 to 2000 meter square per gram (m²/g), preferably from 250 to 1500 m²/g, as determined by low temperature nitrogen absorption in accordance with ASTM D 3037-78; a pore volume of from 1 to 4 milliliters per gram (mL/g), as determined by mercury porosimetry; and, a pore diameter of from 25 to 1000 Angstroms, as determined by mercury porosimetry.

Exemplary commercial conductive carbon blacks which may have utility herein include: Super P, available from Imerys; Black Pearls 2000®, Vulcan® XC-72, Vulcan® 3C and Vulcan® C available from Cabot Corporation; and; Ketjenblack®, available from Nouryon.

In an embodiment, the conductive carbon additive may include carbon fibers. It is preferred that the carbon fibers are characterized by least one of the following parameters: an aspect ratio of from about 5 to about 2000, for instance of from about 20 to about 2000; a mean length of from about 1 to about 20 mm, for instance from about 1 to about 15 mm; and, a mean diameter of from about 1 to about 50 μm, preferably from about 5 to about 25 μm; a tensile strength of at least about 1000 MPa, for instance at least about 2000 MPa; and, an elastic modulus of at least about 105 MPa, for instance at least about 10⁶ MPa. These characterizations of the conductive fiber are not mutually exclusive: the fibers may meet one, two, three, four or five thereof.

As is known in the art, carbon fibers may be classified by the precursors from which they are derived. Polyacrylonitrile (PAN), pre-oxidized polyacrylonitrile, isotropic-pitch- and mesophase-pitch-based carbon fibers are produced by the wet (solution) spinning of each precursor followed by oxidative stabilization and carbonization (or graphitization) at a temperature up to 1300° C. Vapor-grown carbon fibers are prepared by thermal decomposition of a hydrocarbon vapor, such as methane (CH₄), in which method oxidative stabilization is not needed. There is no intention in the present disclosure to limit the precursor from which the carbon fibers are obtained.

Exemplary commercial carbon fibers having utility herein include: Pyrograf® III carbon fibers, available from Pyrograf Products Inc; and, Thornel® carbon fibers, available from Solvay.

A plethora of carbon fiber configurations within the composite material are envisaged. Fibers may, for instance, be disposed within the binder matrix in a random comingled form, in woven form, as a non-woven web or as a fibrous tape. Alternatively, or additionally, fibers may be dispersed within the polymeric matrix in a unidirectional manner.

In an embodiment, the composite electrode comprises at least one of carbon black, carbon nanotubes and carbon nanostructures. The presence of carbon black and carbon nanotubes in the composite electrode, either alone or in combination may be mentioned, in particular.

Exemplary binders—which may be used alone or in combination—include but are not limited to: polycarbonate; polystyrene; acrylonitrile butadiene styrene copolymers (ABS); styrene acrylonitrile copolymers (SAN); styrene butadiene styrene copolymers; styrene ethylene propylene styrene copolymers; polyvinyl chloride; polyvinylidene fluoride (PVDF); polyolefins, such as polypropylene, polyethylene, and polybutylene; polyamide; polyimide; polyamideimide; polyether imide; polyethylene terephthalate; polybutylene terephthalate; polyethylene naphthalate; polymethyl methacrylate; tetrafluoroethylene hexafluoro ethylenic copolymer, a tetrafluoroethylene hexafluoropropylene copolymer (FEP), a tetrafluoroethylene perfluoroalkyl vinyl ether copolymer (PFA), ethylene-tetrafluoroethylene copolymer (ETFE resin), polychlorotrifluoroethylene resin (PCTFE), a propylene-tetrafluoroethylene copolymer, an ethylene-chlorotrifluoroethylene copolymer (ECTFE); ethylene-acrylic acid copolymer; ethylene butyl acrylate copolymers; polyacrylonitrile; polyetherketone; polyarylketone; polyethersulfone (PES); polyarylsulfone; polysulfone; polyphenylene sulfide; polyurethane; polyurea; polybenzoxazole; polyoxadiazol; polybenzothiazole; polybenzimidazole; polypyridine resin; polytriazole; polypyrrolidone; polydibenzofuran resin; and, polyphosphazene.

A preference may be noted for the use in or as the binder of: polyolefins, in particular polypropylene; polyamides, in particular polyphthalamide (PPA); polyphenylene sulfide (PPS); and PVDF. In a preferred embodiment, the binding polymer is PVDF. The composite electrode may include from about 1-10 wt. %, for example about 2-9 wt. %, about 3-8 wt. %, about 4-7 wt. %, or about 5-6 wt. % of binder, based on the weight of the composite electrode.

At step 74, the method 70 includes grinding the third mixture to obtain a second slurry. Grinding may typically be realized by introducing the mixture into a milling chamber into which is also charged grinding media. A stirring device of some form can then be used to agitate the grinding media, thereby causing the solid particles of the mixture to be ground. Alternatively, the grinding media can be set in motion by either applying planetary, tumbling or vibratory motion to the milling chamber, or subjecting magnetic grinding media that has been charged to the milling chamber to an alternating or fluctuating magnetic field.

The type of grinding media charged to the milling chamber is generally selected from any variety of dense, tough, hard materials, such as sand, stainless steel, zirconium silicate, zirconium oxide, yttrium oxide, glass, alumina, titanium, and the like. Typically, the grinding media charged to the milling chamber includes spherically shaped media milling beads. Spherically shaped grinding media may be preferred on account of its mechanical stability and the absence of edges or features which may be attrited.

In addition to media mills, the obtained mixture may also be ground to a slurry using other known wet milling devices such as colloid mills, pressure homogenizers and rotor stators. Other exemplary techniques for grinding include, but not limited to, manual grinding methods such as mortar and pestle, hand-held grinders, and manual ball mills, and mechanical methods such as jet milling, vibratory milling, hammer milling, planetary milling, and cryogenic grinding. In a preferred embodiment, the grinding is done via wet-milling using a high energy ball milling machine. As used herein, the term ‘high energy ball milling (HEBM)’ refers to powdered milling processes that facilitate alloying on an atomic level. As such, they utilize substantially larger impact energies than other powdered milling techniques, such as planetary milling or attritor milling, wherein, due to the physical design of the equipment, the energy given to the powder is less.

At step 76, the method 70 includes casting the second slurry onto an aluminium foil to obtain a casted slurry. Exemplary casting techniques include, but not limited to, sand casting, die casting, investment casting, permanent mold casting, lost foam casting, centrifugal casting, shell molding, continuous casting, and doctor blade casting. In a preferred embodiment, the second slurry is cast onto an aluminium foil by doctor blade casting technique. The doctor blade technique is a thin-film casting method that uses a blade set at a specified gap height to spread a slurry or suspension across a substrate (such as glass or aluminium foil), ensuring a uniform coating thickness as the substrate moves under the blade.

Prior to casting the slurry, it is often advisable to pre-treat the relevant surfaces to remove foreign matter there from. Such treatments can be performed in a single or multi-stage manner and may be constituted by, for instance, the use of one or more of: an etching treatment with an acid suitable for the foil substrate and optionally an oxidizing agent; sonication; plasma treatment, including chemical plasma treatment, corona treatment, atmospheric plasma treatment and flame plasma treatment; immersion in a waterborne alkaline degreasing bath; treatment with a waterborne cleaning emulsion; treatment with a cleaning solvent, such as carbon tetrachloride or trichloroethylene; and, water rinsing, typically with deionized or demineralized water. In those instances where a waterborne alkaline degreasing bath is used, any of the degreasing agent remaining on the surface may be removed by rinsing the foil substrate surface with deionized or demineralized water.

The slurry is then applied to the optionally pre-treated, optionally primed surfaces of the foil substrate by conventional application methods such as: immersion; coating dies; roll coating; doctor-blade coating; and, spraying methods, including but not limited to gas-assisted spray, gasless spray and high-volume low-pressure spray. It is recommended that the slurry be applied to a surface at a wet film thickness of from about 10 to about 500 μm. The application of thinner layers within this range is more economical and provides for a reduced likelihood of deleterious thick dried regions. However, control must be exercised in applying thinner coatings or layers so as to avoid the formation of discontinuous cured films.

At step 78, the method 70 includes drying the casted slurry in a conventional oven at a third temperature for a third duration to obtain a dried slurry. In some embodiments, the third temperature is from about 200-350° C., for example about 210-340° C., about 220-330° C., about 230-320° C., about 240-310° C., about 250-300° C., about 260-290° C., or about 270-280° C.

Independently or, or additional to the selected temperature, the third duration may be from about 0.5-12 hours, for example from 1-11 h, about 2-10 h, about 3-9 h, about 4-8 h, or about 5-7 h.

Conventional ovens may be used to heat the cast slurry. The temperature that is suitable depends on the specific compounds present and the desired curing rate and can be determined in the individual case by the skilled artisan, using simple preliminary tests if necessary.

After conventional drying, the dried slurry should desirably substantially retain its shape upon the film substrate. By “substantially retain its shape” is meant that at least 50% by volume, and more usually at least 80% or 90% by volume of the dried slurry retains its shape and does not flow or deform upon exposure to ambient conditions for a period of 5 minutes. Under such circumstances, gravity typically may not substantially impact the shape of the at least partially cured or partially dried layer upon exposure to ambient conditions.

At step 80, the method 70 includes vacuum drying the dried slurry at a fourth temperature for a fourth duration to obtain the composite electrode. In some embodiments, the fourth temperature is from about 200-350° C., for example about 210-340° C., about 220-330° C., about 230-320° C., about 240-310° C., about 250-300° C., about 260-290° C., or about 270-280° C. Independently of, or additional to the applied fourth temperature, the fourth duration may be from about 0.5-12 hours, for example about 1-11 h, about 2-10 h, about 3-9 h, about 4-8 h, or about 5-7 h.

The final composite electrode may be represented as a coating disposed on the aluminium foil. The coating weight may typically be from about 0.1 to about 5 mg/cm², for example from about 1 to about 5 mg/cm² or from about 1 to about 3 mg/cm².

In an embodiment, an all-solid-state lithium metal battery is described. The all-solid-state lithium metal battery comprises: an anode comprising lithium and being capable of insertion and extraction of Li⁺ ions; a cathode capable of insertion and extraction of Li⁺ ions; and, a solid-state electrolyte disposed between the anode and cathode and including the aforementioned solid-state polymer electrolyte. The all-solid-state lithium metal battery is fabricated in a coin-cell structure.

Exemplary anode active materials may include lithium, a lithium alloy and lithium titanate (LTO). In one embodiment, the anode may include a current collector and a coating of a lithium-ion active material on the current collector. Standard current collector materials include but are not limited to: aluminium; copper; nickel; stainless steel; carbon; carbon paper; and, carbon cloth. In one aspect, the anode may be a sheet of lithium metal serving both as an active material and current collector.

The cathode structure may be any conventionally employed in lithium-ion batteries, including but not limited to composite lithium metal oxides such as, for example, LiCoO₂, LiMn₂O₄, LiFePO₄, and MNC (lithium nickel manganese cobalt oxides). Other active cathode materials may also include elemental sulfur and metal sulfide composites. The cathode may also include a current collector such as copper, aluminium and stainless steel. Alternative chalcogenides to sulfur, such as selenium and tellurium, may also be employed as active cathode materials. Mixtures of any of these may also be employed.

As described throughout this disclosure, the solid-state polymer electrolyte according to various embodiments and aspects described herein may have utility where metal ion conductivity and low electrical conductivity is required. Therefore, the solid polymer electrolyte may be useful as components of electrode compositions.

The following examples are provided solely for illustration and are not to be construed as limitations of the present disclosure, as many variations thereof are possible without departing from the spirit and scope of the present disclosure.

### EXAMPLES

The following examples demonstrate a composite polymer electrolyte including a zirconium (IV) benzene-1,3,5-tricarboxylate (BTC) metal-organic framework (MOF). The examples are provided solely for illustration and are not to be construed as limitations of the present disclosure, as many variations thereof are possible without departing from the spirit and scope of the present disclosure.

### Example 1: Materials

Lithium bis(trifluoromethylsulfonyl)imide (LiTFSI) was purchased from Solvay. Super P: Carbon black, obtained from Imerys. Polyethylene oxide (PEO) with a weight average molecular weight of 1000 kilodaltons and a melting temperature of 70° C., ZR8: Zirconium-based metal-organic framework (MOF-808) with a molar ratio of Zr:benzene-1,3,5-tricarboxylic acid of about 3:1 (CAS No. 1579984-19-2), and lithium iron phosphate (LiFePO₄, LFP) were purchased from MTI Korea. The remaining compounds of the Examples were acquired from Sigma Aldrich.

### Example 2: Synthesis of ZR8 (MOF-808)

Zirconium tetrachloride (ZrCl₄, 1.05 grams (g), 4.5 millimoles (mmol)) was dissolved in 99.5% acetic acid solution of 45 milliliters (mL), while BTC (0.31 g, 1.5 mmol) was dissolved in dimethylformamide (DMF) under ultrasonication for 30 minutes (min). After sonication, the ZrCl₄ and BTC solutions were combined—to provide a molar ratio of ZrCl₄ to BTC of 3:1—and the mixture heated to 120 degrees Celsius (° C.) for 72 hours (h) in a Teflon-lined high-pressure reactor. The resulting reaction product was washed four times with acetone, followed by drying at 100° C. for 12 hours. Subsequently, the sample was activated in chloroform (CHCl₃) for three days at 50° C., with daily replacement of CHCl₃. Finally, the sample was dried under vacuum at 120° C. for 24 hours to obtain the ZR8 (MOF-808) samples.

### Example 3: Materials Characterization

Universal testing machine (United Calibration, SFM-100 kN) was utilized to measure the stress-strain scales of the composite polymer electrolyte (CPE). Differential scanning calorimetry (DSC, Q2000 T A Instruments) was utilized to investigate the phase transition behaviour. Thermal stability was examined using Thermogravimetric analysis (TGA, Q500 TA Instruments). An X-ray diffractometer (XRD, Empyrean-Malvern Panalytical) was used to study the structural properties using Cu Kα radiation. The morphological examination was carried out using field emission scanning electron microscopy (FE-SEM, Hitachi, S-4800). The chemical bonding analysis was performed using X-ray photoelectron spectrometry (XPS, M/s Thermo Scientific, ESCALAB 250Xi). Raman spectra were recorded on a 780 nm in Via Raman microscope spectrometer (Raman, Thermo Scientific/Nicolet Almega XR). The heat release rate (HRR) was measured using a micro-combustion calorimeter (MCC, Fire testing technology, FTT0001). The HRR measurement was conducted on a 15 milligrams (mg) sample at a heating rate of approximately 1 degree Celsius per second (° Cs⁻¹), within the 150-800° C. temperature range. The gas used for the experiment was a mixture of nitrogen (N₂) and oxygen (O₂) in an 80:20 ratio.

### Example 4: Electrochemical Characterization

The electrochemical characterization was performed by using a battery cycler (WBCS3000, WonATech), and a potentiostat (ZIVE MP1, WonATech). The cells were activated at 70° C. for 2 hours before each electrochemical measurement to ensure good contact between the electrodes and electrolytes. The ionic conductivities of the composite polymer electrolytes (CPEs) in the temperature range of 20 to 70° C. were measured by electrochemical impedance spectroscopy (EIS) in the frequency range of 2 megahertz (MHz) to 50 millihertz (mHz), with an applied amplitude of 5 mV. The ionic conductivities (in Scm⁻¹) of the CPEs were calculated using Eq. 1.

$$σ = \frac{L}{R \times S} \qquad ( 1 )$$

where R (in ohm (Ω)) is the value of charge transfer resistance extracted from the Nyquist plot, L (in cm) is the thickness of the electrolyte film, and S (in cm²) is the cross-sectional area of the electrolyte film, respectively. Before each measurement, the stainless steel (SS) symmetric cell (SS/CPE/SS) was thermally stabilized for 2 hours. The electrochemical stability of the ZR8-CPE was investigated by linear sweep voltammetry (LSV), which was conducted at a scan rate of 0.1 millivolts per second (mVs⁻¹) in a voltage range of 2.6 to 6.0 V (vs. Li/Li⁺). The lithium-ion transference number (t_{Li+}) of the ZR8-CPE was determined by chronoamperometry, based on the DC polarization and AC impedance. DC polarization voltage of 10 mV was applied to the cell to measure the initial and steady currents and Nyquist plots before and after DC polarization were obtained by AC impedance spectroscopy. Lithium stripping deposition cycling was performed to investigate the influence of ZR8-CPE on the electrochemical performance of lithium metal anode. Galvanostatic cycling were performed 5 within the potential window of 2.6 to 4 volts (V). The LFP/CPE/Li half-cell was cycled by using CR2032 coin cell to investigate the cycle stability and rate performance.

### Example 5: Preparation of Composite Polymer Electrolytes (CPE)

Prior to CPE preparation, PEO (Mw, 1000 kilodalton (kDa)) was dried overnight in a vacuum oven at 60° C. In addition, LiTFSI and MOF-808 were independently dried at 120° C. for 12 h in a vacuum oven. All dried components were stored in an argon-filled glove box prior to use.

Four mixtures were prepared by dispersing LiTFSI (0.16 g) and each of the different amounts of ZR8 documented in Table 1 herein in acetonitrile (ACN) in a beaker: the contents of the beakers were stirred at 300 revolutions per minute (rpm) for 24 hours using a magnetic stirrer to obtain homogeneous mixtures. Subsequently 0.4 g of PEO was added to these LiTFSI and ZR8 homogeneous mixtures, which were then stirred for an additional 24 hours. The molar ratio of the residues of ethylene oxide (EO) in the PEO to Li⁺ in the mixtures was 16:1 and the content of ZR8 was varied between 2.5 and 10 wt. %, based on the solids content of the mixtures. The homogeneous mixtures were then ball-milled for 45 minutes at 200 rpm in a high-energy ball mill to obtain uniform slurries. Each slurry was poured into a Teflon dish inside an argon-filled glove box to evaporate acetonitrile. Subsequently, the at least partially dried slurries were each transferred to a vacuum oven at 60° C. for 12 hours to volatilize any residual solvent.

Based on the different weight percentages of ZR8 which were used—specifically 2.5 wt. %, 5 wt. %, 7.5 wt. % and 10 wt. %, based on the weight of the composite polymer electrolytes—the CPEs are termed as ZR8-2.5, ZR8-5, ZR8-7.5, and ZR8-10, respectively in Table 1. Where these composites share general properties, they may be referred to herein as ZR8-CPEs.

A comparative solid polymer electrolyte (hereinafter CCPE) was synthesized in the above-described manner but without the addition of ZR8.

TABLE 1
Composition of PEO, LiTFSI, and ZR8 dispersed in acetonitrile
(15 mL) for the synthesis of SPE and ZR8-CPEs.

| Sample Name | PEO (g) | LiTFSI (g) | ZR8 (g) |
|---|---|---|---|
| ZR8-2.5 | 0.4 | 0.16 | 0.014 |
| ZR8-5.0 | 0.4 | 0.16 | 0.028 |
| ZR8-7.5 | 0.4 | 0.16 | 0.042 |
| ZR8-10 | 0.4 | 0.16 | 0.056 |
| CCPE | 0.4 | 0.16 | |

### Example 6: Structural and Morphological Studies

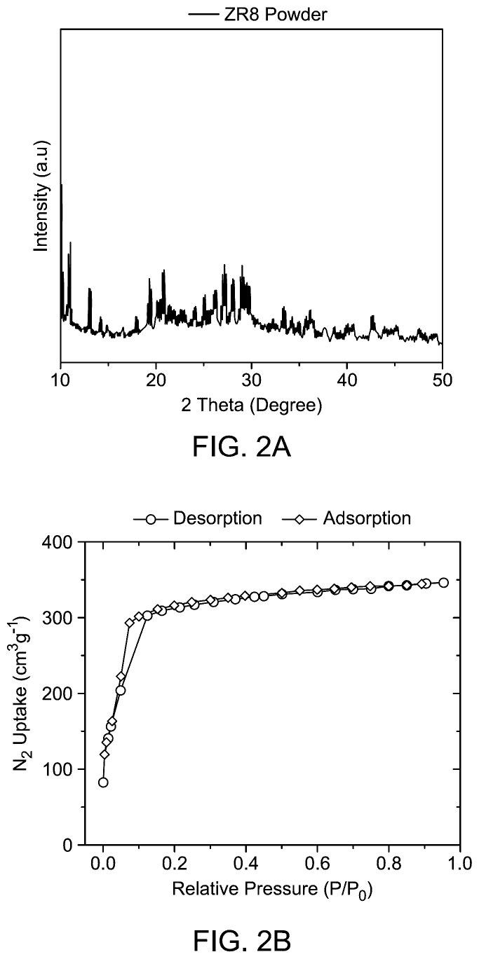

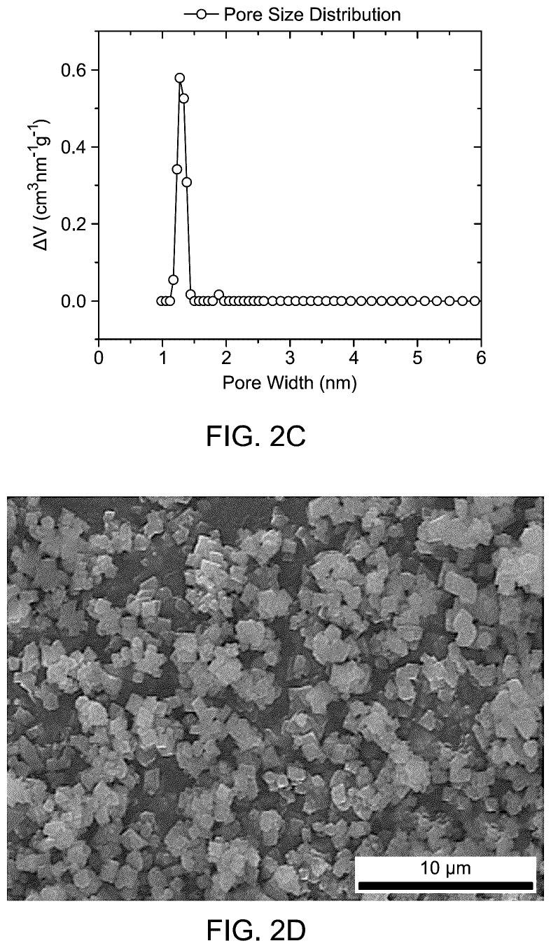

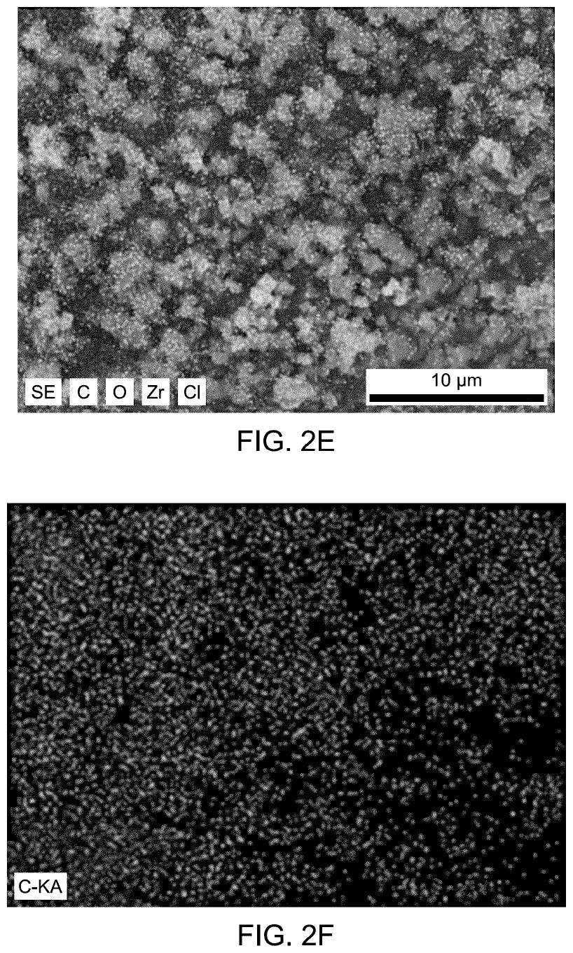

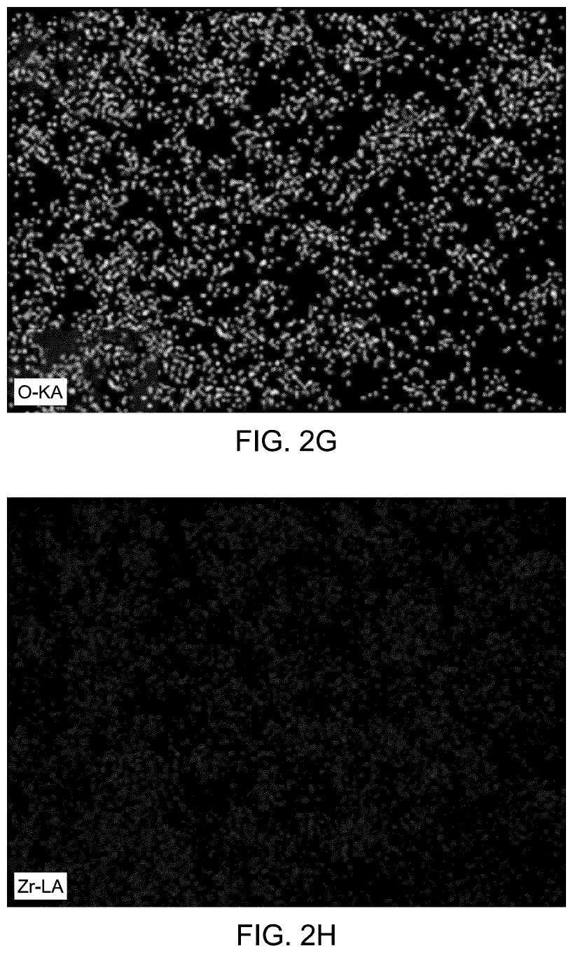

The identity of the obtained ZR8 (MOF-808) was confirmed by XRD. FIG. 2A shows XRD pattern of ZR8 powder. FIG. 2B shows N₂ adsorption-desorption isotherms of ZR8 and FIG. 2C shows pore size distributions of ZR8. The synthesized ZR8 had a median pore diameter of 1.4 nanometer (nm), as determined by Barrett-Joyner-Halenda (BJH) desorption analysis, which is in accordance with known literature values.

The FE-SEM image of the obtained ZR8 powder is shown in FIG. 2D appended hereto. The SEM-energy dispersive X-ray (EDX) map of the ZR8 powder is shown in FIG. 2E appended hereto. The SEM-EDX elemental mapping images of ZR8 powder are shown in FIGS. 2F-2I revealing the uniform distribution of elements, including C, O, Zr, and Cl, respectively.

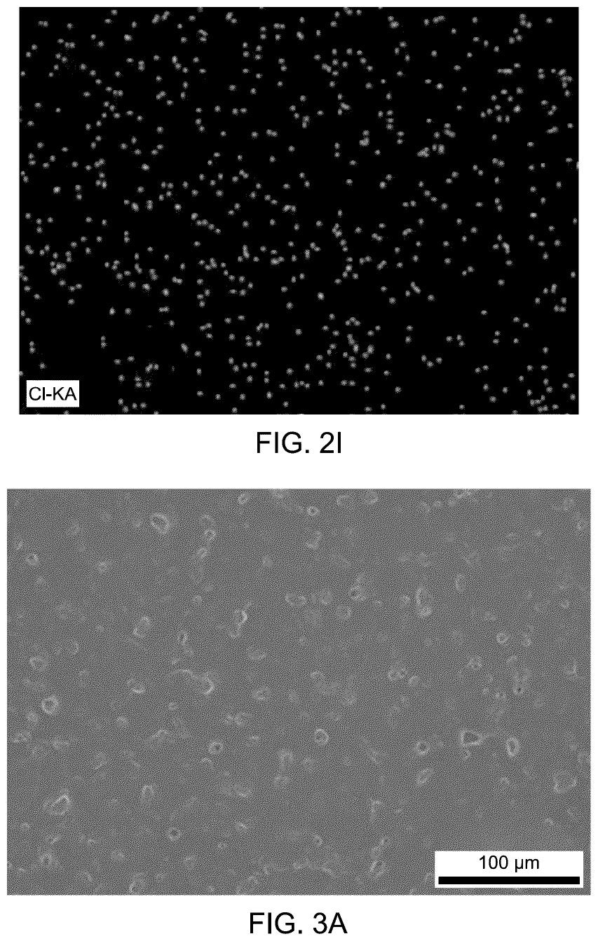

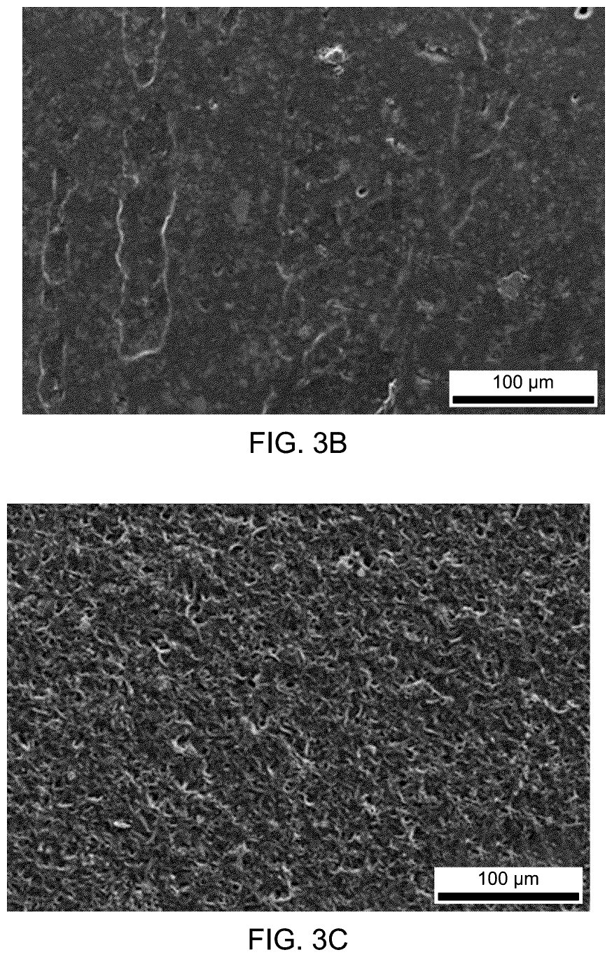

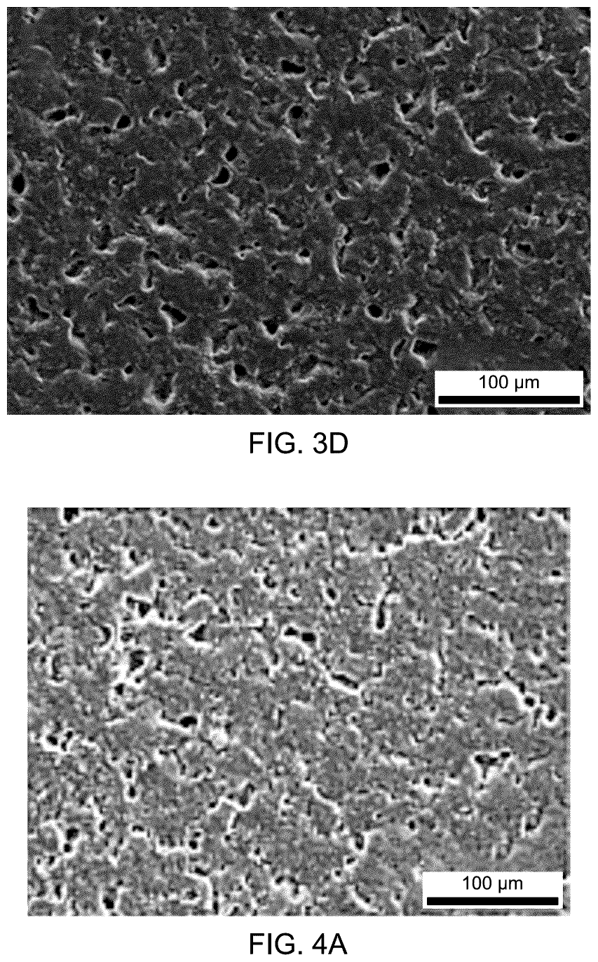

The SEM images of 2.5 wt. % ZR8-CPEs, 5 wt. % ZR8-CPEs, 7.5 wt. % ZR8-CPEs, and 10 wt. % ZR8-CPEs are shown in FIGS. 3A-3D, respectively, appended hereto. An increase in the hole size is observed as the amount of ZR8 increases from 2.5 wt. %, to 5 wt. % to 7.5 wt. % and to 10 wt. % in the solid polymer electrolytes. This increase may be attributed to the addition of ZR8 particles to the PEO matrix and it is postulated that the increase in hole size may be concomitant with improved mechanical strength and resistance to fracture.

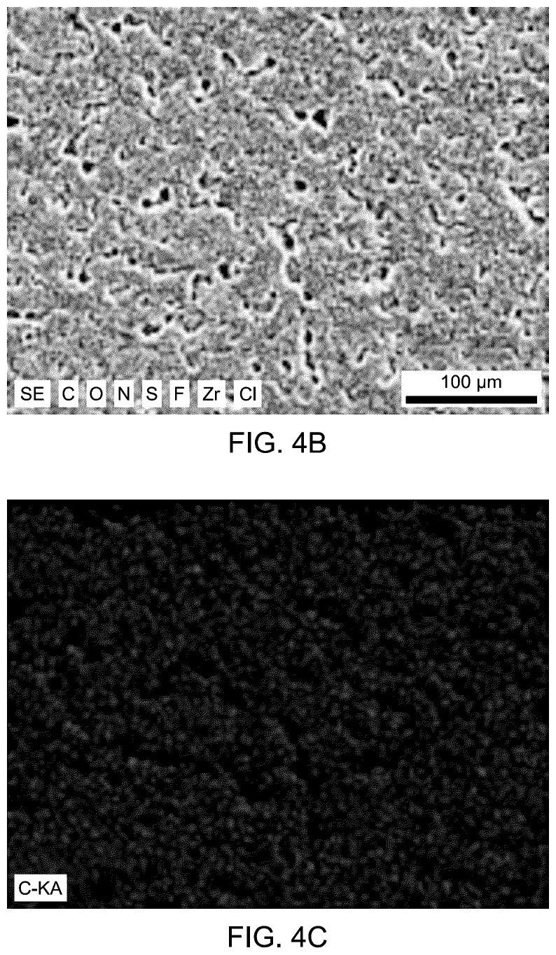

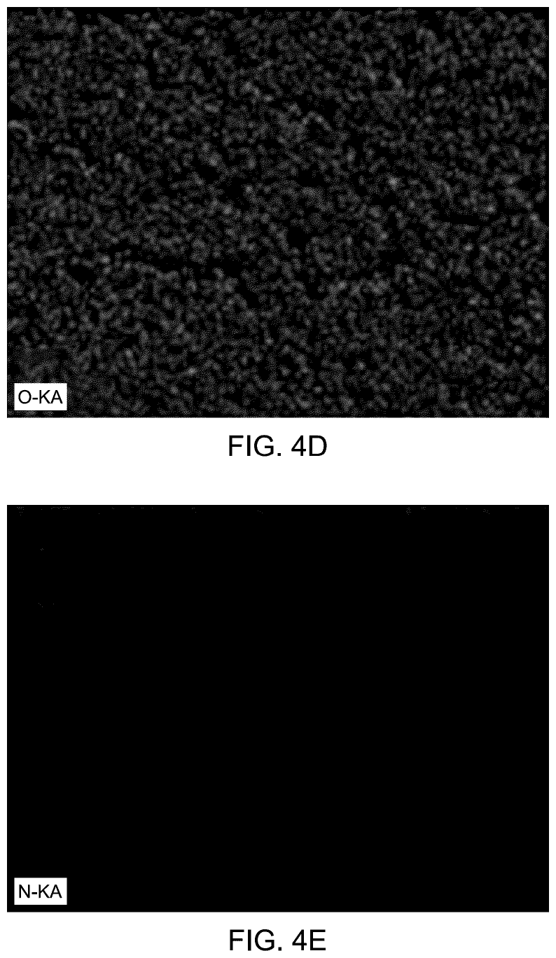

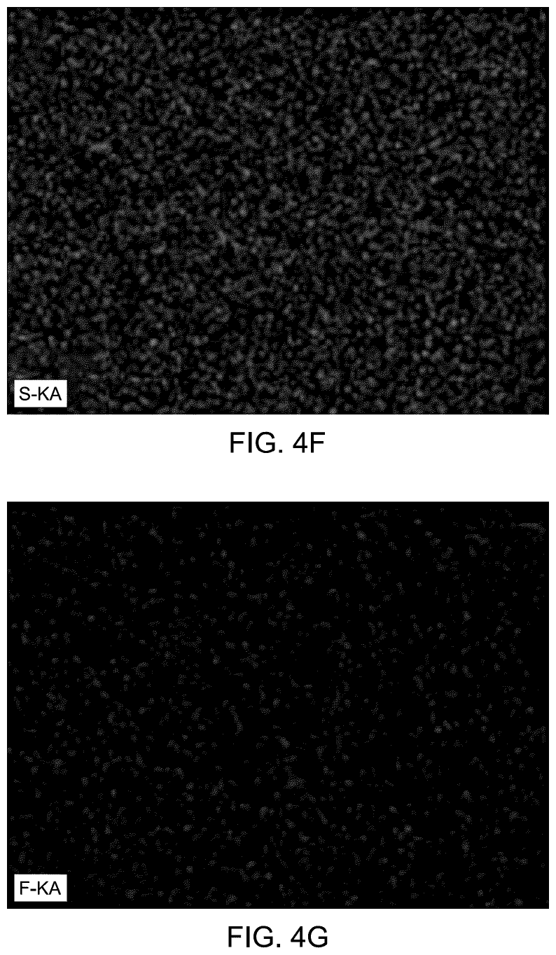

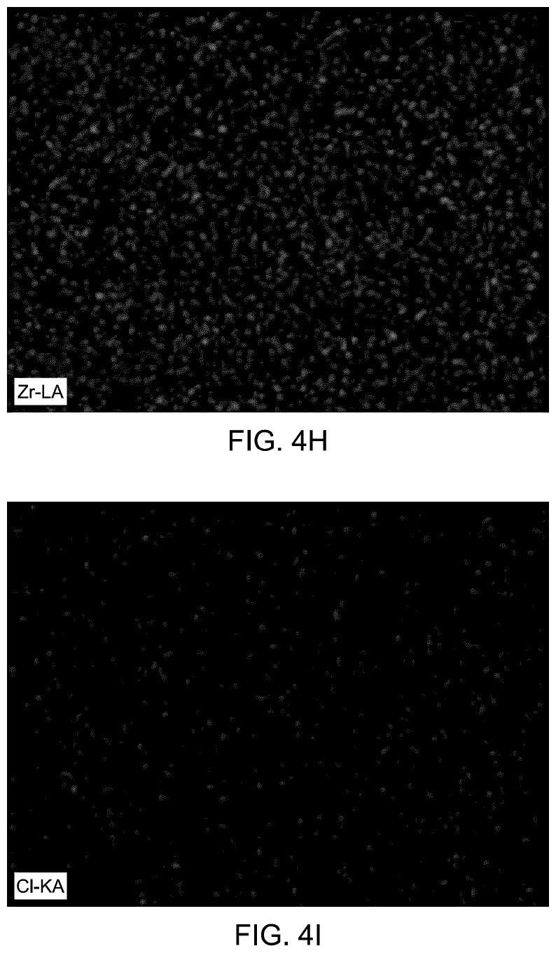

The FE-SEM image of ZR8-7.5 CPE is shown in FIG. 4A appended hereto. The SEM-EDX map of ZR8-7.5 CPE is shown in FIG. 4B appended hereto. The SEM-EDX elemental mapping images of ZR8-7.5 CPE are presented in FIG. 4C-4I appended hereto, showing the presence of C, O, N, S, F, Zr, and Cl, respectively.

### Example 7: Optical Images, Ductility and Flexibility

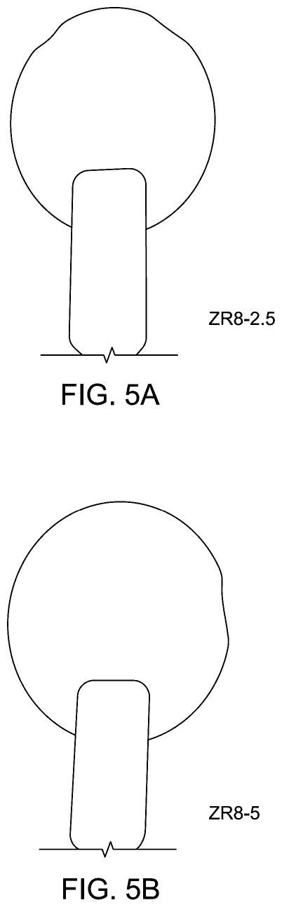

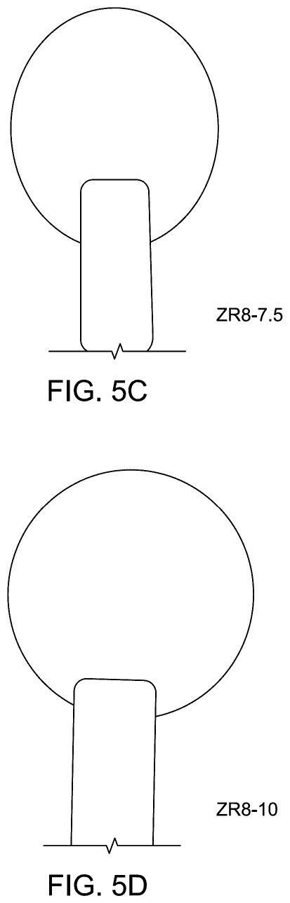

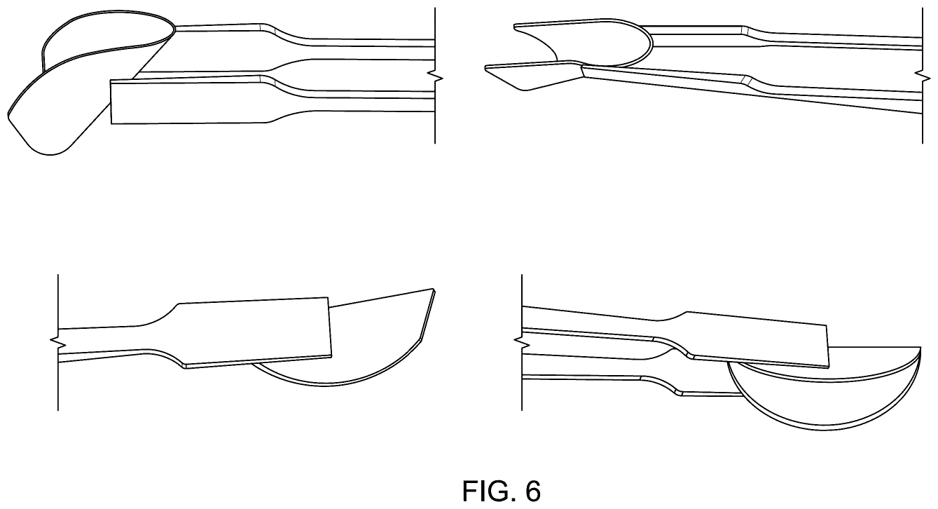

The optical images of all ZR8-CPEs, including those with ZR8 content of 2.5, 5, 7.5, and 10% are shown in FIG. 5A-5D, respectively. Further, for ZR8-7.5 CPE, FIG. 6 appended hereto shows the optical images of this composite electrode when subjected to different bending conditions. As is evident from these images, this prepared electrolyte exhibits good mechanical ductility and flexibility. There are, moreover, no apparent observations of stress before and after film bending.

### Example 8: Differential Scanning Calorimetry (DSC)

The impact of the ZR8 filler on the crystallization and phase transition behavior of PEO-based electrolytes was studied using differential scanning calorimetry (DSC) performed on Q2000 T A Instruments. The enthalpy of melting (ΔHₘ), degree of crystallinity (χ_{c}), and melting temperature (Tₘ) of CPEs are summarized in Table 2. The χ_{c} was calculated using the Eq. 2

$${χ}_{c} = Δ {H}_{m} / Δ {H}_{0} \qquad ( 2 )$$

wherein ΔH₀ is the melting enthalpy of 100% crystalline PEO (213.7 joules per gram (Jg⁻¹)).

TABLE 2
DSC data for phase transition behavior of SPE and ZR8-CPEs
including the values of Tₘ, ΔHₘ, and χ_{c}.

| Sample Name | Tₘ (° C.) | ΔHₘ (Jg⁻¹) | χ_{c} (%) |
|---|---|---|---|
| CCPE | 49.18 | 50.42 | 23.59 |
| ZR8-2.5 | 48.47 | 41.72 | 19.52 |
| ZR8-5.0 | 44.68 | 41.48 | 19.41 |
| ZR8-7.5 | 42.49 | 36.21 | 16.94 |
| ZR8-10 | 48.40 | 48.37 | 22.64 |

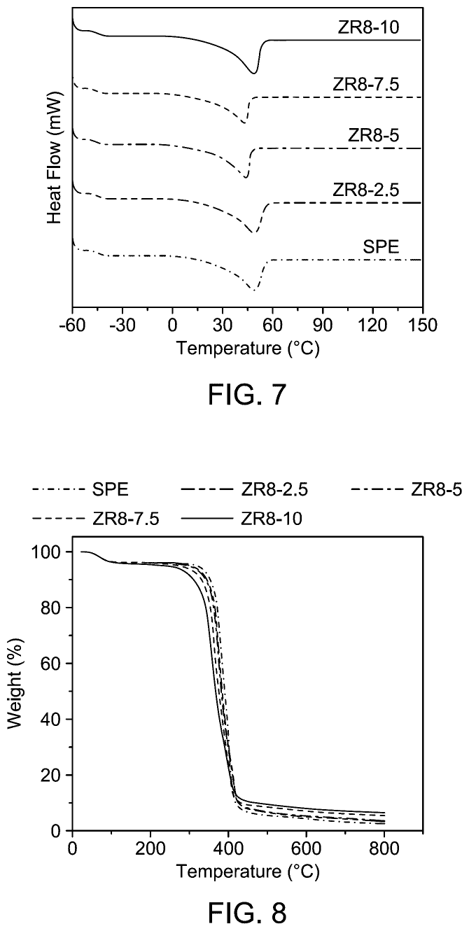

FIG. 7 appended hereto displays the thermal properties of CCPE and ZR8-CPEs as determined by differential scanning calorimetry (DSC). The endothermic valleys associated with electrolyte film melting were observed at 49.18, 48.47, 44.68, 42.49, and 48.40° C. for the SPE and CPEs with ZR8 contents of 2.5, 5, 7.5, and 10 wt. %, respectively. In the comparison of the Tₘ with that of PEO (˜70° C.) as already reported, a characterized absorption peak is exhibited at 49.18° C. for the CCPE. The addition of 2.5 and 7.5 wt. % ZR8 in the solid polymer electrolyte resulted in a shift of the Tₘ to 48.47 and 42.49° C., respectively. Consequently, ZR8-7.5 exhibits a lower χ_{c} of 16.94% than that of CCPE (23.59%), indicating that the ZR8 filler can increase the amorphous phase of the PEO matrix. In addition, the Tₘ and χ_{c} gradually decrease with the addition of ZR8 into the CCPE. Significantly, the χ_{c} decreases to a minimum of 16.94% when the content of ZR8 reaches 7.5%, indicating that ZR8-7.5 has the highest proportion of amorphous regions and infers this may be the most Li⁺ conductive composite polymer electrolyte (CPE).

Furthermore, the thermal analysis reveals no new endothermic peak, indicating that ZR8 is uniformly distributed in the PEO/LiTFSI system, and no apparent phase separation occurs. As expected, with further addition of ZR8 to 10 wt. % content, the values of Tₘ and χ_{c} begin to increase, which can be attributed to the agglomeration of ZR8 in the PEO/LiTFSI system, as observed in XRD. Therefore, as can be concluded by combining the crystallinity trends obtained from XRD and DSC, the ZR8 filler significantly improves the proportion of the amorphous region.

### Example 9: Thermogravimetric Analysis (TGA)

The TGA of the solid polymer electrolytes was performed using Q500 TA Instruments.

FIG. 8 provides the TGA curves of the CCPE and the ZR8-2.5, ZR8-5, ZR8-7.5, and ZR8-10 composite polymer electrolytes. The observed heat loss below 200° C. may be attributed to the removal of small molecules, including adsorbed trace water and solvent. As the temperature increases, the CCPE and the ZR8-CPEs each exhibit irreversible decomposition between 300 to 400° C., the specific thermal decomposition temperatures being recorded in Table 3.

The weights remaining after heating the CCPE and the ZR8-2.5, ZR8-5, ZR8-7.5 and ZR8-10 CPEs to 800° C. are also provided in Table 3.

TABLE 3
TGA data of SPE and ZR8-CPEs decomposition
temperature and the weight.

| | Decomposition | Weight Remaining |
|---|---|---|
| Sample Name | Temperature (° C.) | after 800° C. (%) |
| CCPE | 335 | 2.51 |
| ZR8-2.5 | 328 | 3.09 |
| ZR8-5.0 | 323 | 3.53 |
| ZR8-7.5 | 318 | 5.37 |
| ZR8-10 | 285 | 6.44 |

With higher filler content, diminishing weight loss was observed. Further, as compared to CCPE, the ZR8-CPEs all demonstrate improved thermal stability and flame-retardancy owing to the presence of ZR8 particles. As the temperature reaches 800° C., the residual weight of the CCPE is the lowest, indicating a higher release of combustible materials from the electrolyte which is devoid of ZR8 particles.

### Example 10: Heat Release Rate (HRR)

The flammability of the polymer electrolytes is confirmed using microcalorimeter (MCC) measurements.

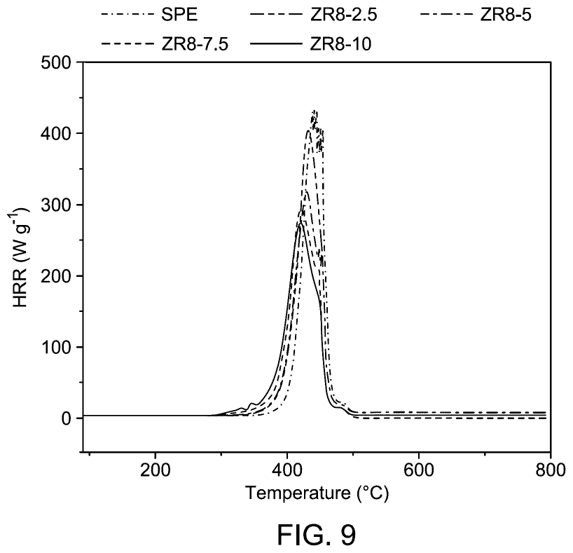

The curves of HRR versus time for CCPE and ZR8-CPEs are shown in FIG. 9. The MCC measurements provided the parameters of HRR, heat release capacity (HRC) and heating rate, which are shown in Table 4 for the CCPE and each of the ZR8-2.5, ZR8-5, ZR8-7.5, and ZR8-10 CPEs. The high HRR (436 watt per gram (Wg⁻¹)) and HRC (473 joules per gram per kelvin (Jg⁻¹K⁻¹)) values of the CCPE indicate a high release amount of pyrolysis products. As further observed in the HRR curves of the CCPE and the ZR8-CPEs, the incorporation of the ZR8 MOF into the solid polymer electrolytes significantly reduces the HRR values, indicating that ZR8 MOF can reduce the HRR of PEO and inhibit its combustion.

TABLE 4
HRR, HRC, and heating rate parameters obtained from
the microcalorimetry flame testing equipment.

| Sample name | HRR (Wg⁻¹) | HRC (Jg⁻¹K⁻¹) | Heating rate (° C. s⁻¹) |
|---|---|---|---|
| CCPE | 436 | 473 | 1 |
| ZR8-2.5 | 411 | 447 | 1 |
| ZR8-5.0 | 327 | 365 | 1 |
| ZR8-7.5 | 297 | 319 | 1 |
| ZR8-10 | 282 | 308 | 1 |

The HRC of a material is a critical factor in assessing its fire hazard and quantifies the heat energy emitted during combustion or when exposed to fire. Higher HRC values indicate greater potential heat release, which can impact the severity and intensity of a fire event. Conversely, materials with low HRC pose a lower fire risk because they generate less heat energy when burned. The HRC parameter, which is related to the fire hazard of the material, decreases as the ZR8 MOF content increases from 2.5 to 10% in the CPEs. This finding clearly indicates that the flammability of the ZR8-CPEs is significantly reduced.

### Example 11: Flame Tests

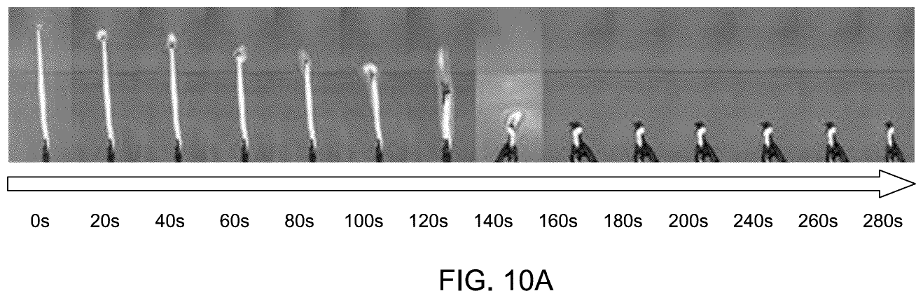

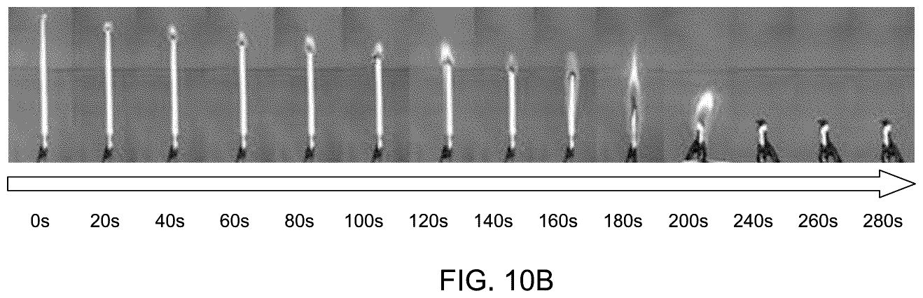

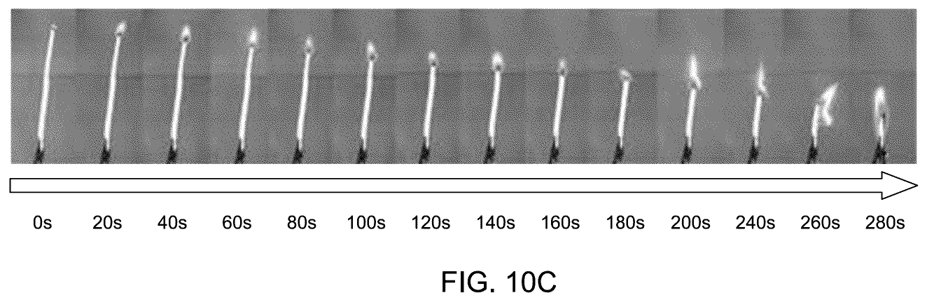

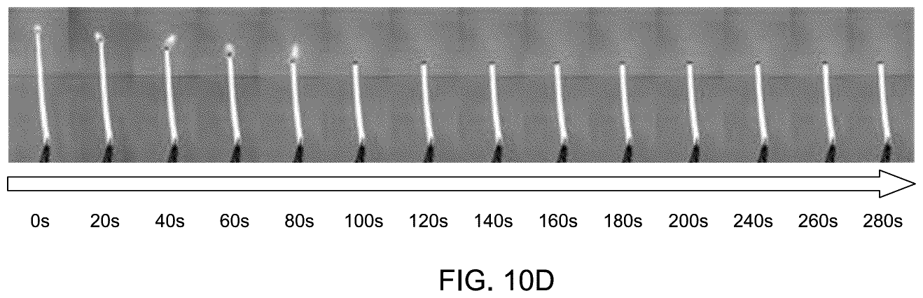

Flame tests were carried out to examine the ignition, flammability and combustion properties of the ZR8-CPEs. The flame resistances of the solid polymer electrolytes were studied by exposing them to an external flame source for 3 seconds (s) and the effect of the ZR8 filler on their fire resistance was then analyzed. The electrolyte films were ignited and monitored for up to 270 seconds. The results are illustrated in FIGS. 10A-10D appended hereto. It is noted that no images are provided for CCPE as this solid polymer electrolyte quickly ignited and burned within 10 seconds.

Upon exposure to the external flame source, the ZR8-2.5 film showed a red flame with a yellow center and eventually softened and deformed after 60 seconds (FIG. 10A). The film was completely burned within 120 seconds, indicating some susceptibility to combustion. The ZR8-5.0 film showed a red-yellow flame during the flame test and started to soften at approximately 170 seconds, indicating that the decomposition of the ZR8-5.0 film resulted in fewer flammable products (FIG. 10B): this behavior suggests that the addition of ZR8-5.0 to the electrolyte film improves its fire resistance. The ZR8-7.5 film showed softening at 250 seconds and complete burning after 260 seconds during the flame test (FIG. 10C). By comparison, the ZR8-10 CPE did not exhibit gradual softening or burning (FIG. 10D); instead, the flame self-extinguished after 100 seconds owing to the thin carbon blanket layer that protected the film from direct contact with environmental oxygen. This carbon layer enhanced the fire-resistant properties of the electrolyte, providing an additional safety advantage to this composite electrolyte.

### Example 12: Tensile Testing

The mechanical properties of polymer electrolytes play an important role in the prevention of lithium dendrite growth, thereby ensuring the safety and stability of lithium-metal batteries (LMBs). To evaluate the mechanical properties of the films, tensile tests were performed under ambient conditions at a constant tensile rate of 10 millimeter per minute (mm/min). The results thereof are summarized in Table 5.

TABLE 5
Parameter of ZR8-CPE's tensile test.

| Sample Name | Stress (MPa) | Strain (%) |
|---|---|---|
| CCPE | 2.59 | 229 |
| ZR8-2.5 | 1.69 | 300 |
| ZR8-5.0 | 1.38 | 296 |
| ZR8-7.5 | 2.35 | 197 |
| ZR8-10 | 3.39 | 209 |

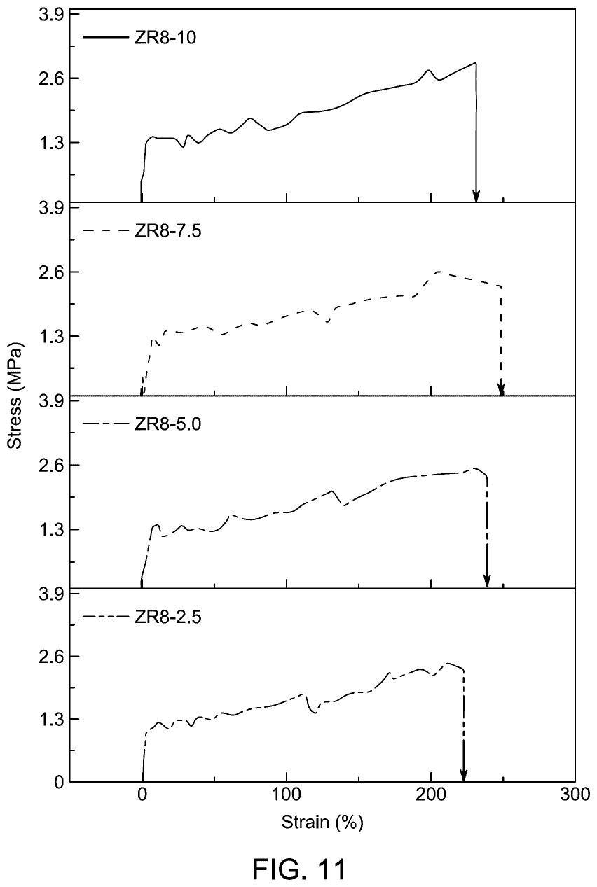

The stress-strain plots of the ZR8-CPEs are further displayed in FIG. 11 appended hereto. This assessment facilitates a better understanding of the influence of ZR8 inclusion on the mechanical behavior of the SPE membranes. The stress values obtained for CCPE, ZR8-2.5, ZR8-5.0, ZR8-7.5, and ZR8-10 are 2.59, 1.69, 1.38, 2.35, and 3.39 megapascals (MPa), respectively. Similarly, the measured strain values for these materials are 229, 300, 296, 197, and 209%, respectively. In the comparison of the stress values, ZR8-2.5 exhibits a slightly lower value (1.69 MPa) than CCPE (2.59 MPa) but has a significantly higher maximum strain of 300% compared to 229% for CCPE.

ZR8-CPEs show improved mechanical properties compared to CCPE: ZR8-CPEs with high stress and strain values may effectively manage mechanical stresses during battery cycling. This can, in turn, hinder dendrite formation and delay short circuits, preserving the structural integrity of the electrolyte. It is considered therefore that ZR8-CPEs can contribute to the improved performance and safety of LMBs by suppressing or delaying short-circuit phenomena in LMBs during cycling.

### Example 13: Raman Spectroscopic Analysis

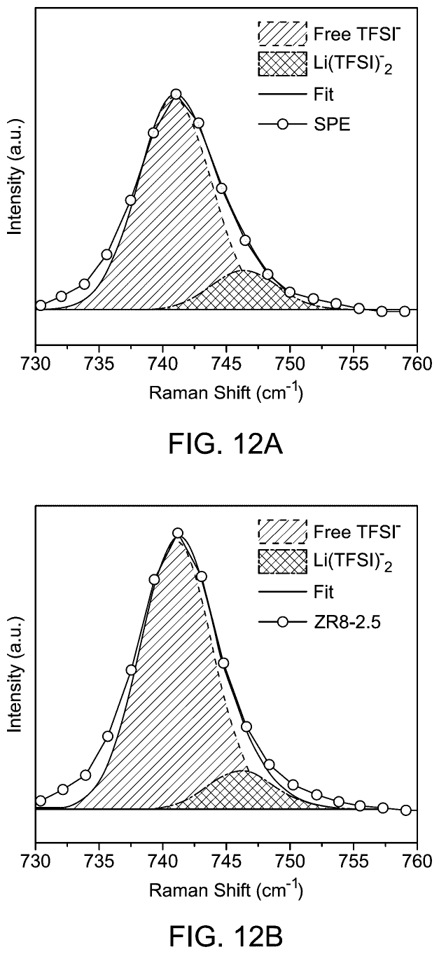

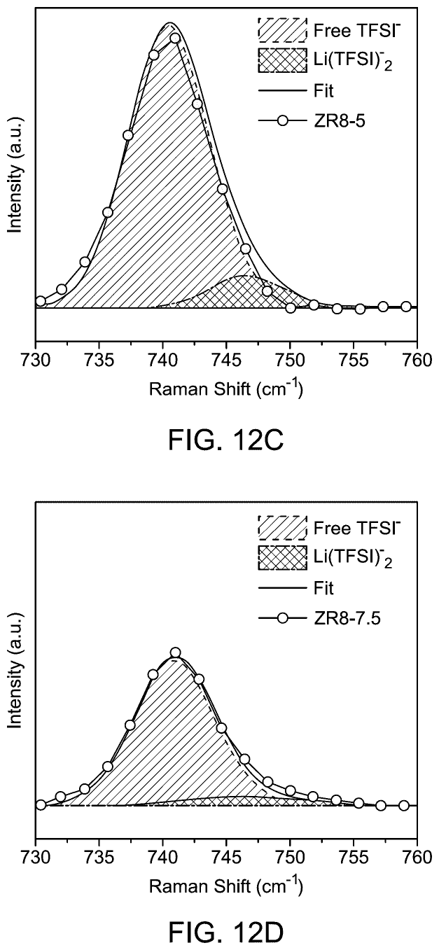

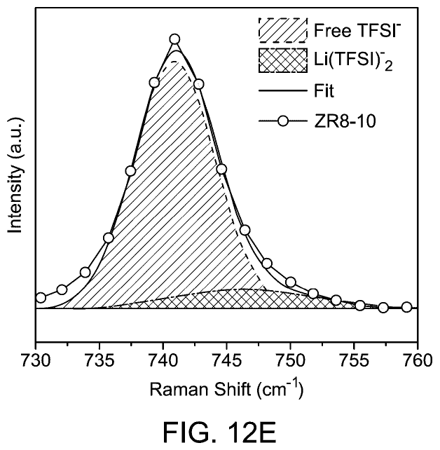

To achieve a better understanding of the interaction between the ZR8 filler and the Li-salt, the Raman band was analyzed within the frequency range of from 730 to 760 cm⁻¹. FIG. 12A-12E illustrates the Raman spectra of CCPE, ZR8-2.5, ZR8-5, ZR8-7.5 and ZR8-10, respectively.

After fitting, a peak at ˜740 cm⁻¹ is observed, corresponding to the TFSI⁻ anion, which measures Li⁺ content and is crucial for achieving high conductivity in solid-state electrodes. Another peak at ˜746 cm⁻¹ corresponds to [Li(TFSI)₂]⁻¹ in the ZR8-CPE samples, indicating the formation of clusters that can negatively affect ionic conductivity. It is observed that the Raman peak intensity of [Li(TFSI)₂] decreases with the addition of the ZR8 filler up to 7.5%. However, beyond this threshold, further increases in the ZR8 content lead to a subsequent increase in the Raman peak intensity of [Li(TFSI)₂]⁻.

The calculated value of the total peak area and the ratio of cluster ion formation can be found in Table 6.

TABLE 6
Raman data for ratio of free-ions and cluster-ions.

| | Peak Area of | Peak area of | Total | |
|---|---|---|---|---|
| | TFSI⁻ | [Li(TFSI)₂]⁻¹ | Peak | % of |
| Sample | (740.14 cm⁻¹) | (745.89 cm⁻¹) | Area | [Li(TFSI)₂]⁻¹ |
| CCPE | 4588.38 | 773.45 | 5361.82 | 14.43 |
| ZRS8-2.5 | 5580.47 | 705.08 | 6285.54 | 11.22 |
| ZRS8-5 | 6690.32 | 650.42 | 7340.77 | 8.86 |
| ZRS8-7.5 | 3453.96 | 272.60 | 3726.56 | 7.32 |
| ZRS8-10 | 5961.12 | 840.62 | 6801.80 | 12.36 |

The ZR8-7.5 CPE displays the highest ionic conductivity, while the ZR8-10 CPE exhibits decreased conductivity; this finding is attributed to cluster formation. It is considered that the ZR8 has the ability to impede the formation of clusters and instead facilitate the dissociation of ion clusters, resulting in the Li-ions being separated from the clusters and absorbed into the nanopores of the metal organic framework. Consequently, Li⁺ diffusion along the surface of ZR8 is promoted, leading to enhanced Li⁺ conductivity.

### Example 14: Ionic Conductivity (σ)

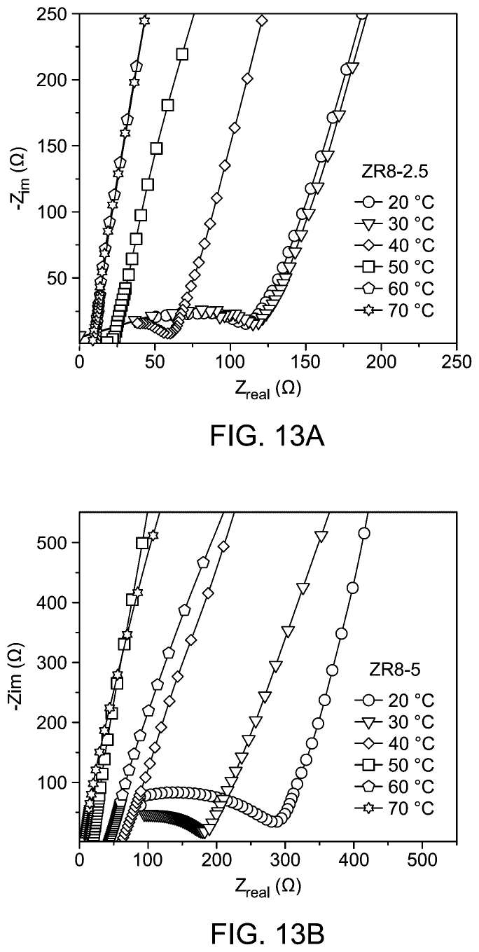

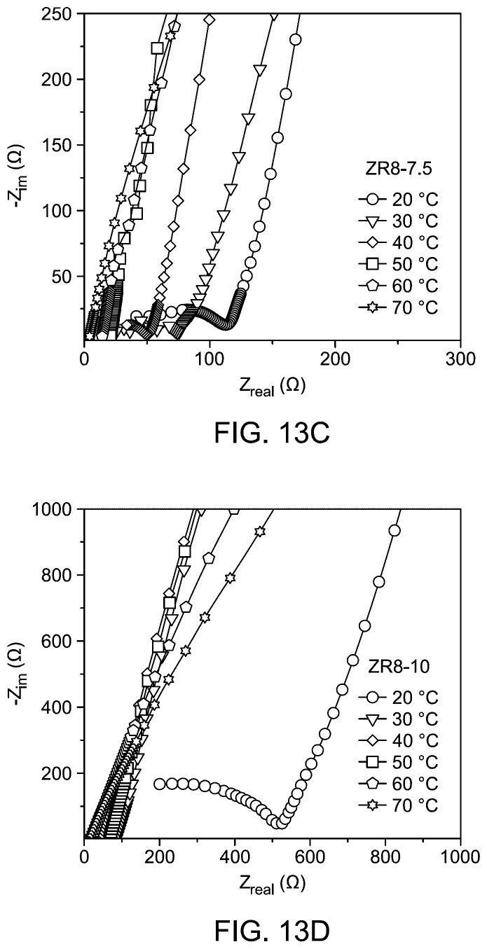

The EIS measurements were performed to estimate the ionic conductivity of the composite polymer electrolytes with varying ZR8 contents. The EIS data for ZR8-2.5, ZR8-5, and ZR8-10, respectively, were collected in the temperature range of from 20 to 70° C. and are presented in FIGS. 13A-13D, respectively and in Table 7.

TABLE 7
Ionic conductivities of ZR8-CPEs, measured at various
temperatures (20, 30, 40, 50, 60, and 70° C.).

| | Ionic Conductivity (σ, 10⁻⁴ S cm⁻¹) | | | | | |
|---|---|---|---|---|---|---|
| Sample | 20° C. | 30° C. | 40° C. | 50° C. | 60° C. | 70° C. |
| ZRS8-2.5 | 0.65 | 0.93 | 1.23 | 5.45 | 6.65 | 12.40 |
| ZRS8-5 | 0.80 | 1.24 | 1.81 | 5.94 | 10.80 | 16.70 |
| ZRS8-7.5 | 1.20 | 2.53 | 3.63 | 7.77 | 13.50 | 27.90 |
| ZRS8-10 | 0.35 | 1.17 | 1.82 | 3.26 | 6.33 | 7.38 |

The results show that the ionic conductivity values of all ZR8-CPEs gradually increase with increasing temperature. It is considered that, as the temperature increases, the transition from crystalline to amorphous domains in the polymer chain promotes segmental mobility at elevated temperatures.

Among all ZR8-CPEs, ZR8-7.5 has the highest ionic conductivity values at each tested temperature. This observation suggests that the inclusion of 7.5 wt. % ZR8 filler may effectively hinder the crystallization of the PEO chain, resulting in the creation of increased amorphous regions conducive to ion transport.

ZR8-10 exhibits lower ionic conductivity values than ZR8-7.5. As the ZR8 filler content further increases from 7.5 wt. % to 10 wt. %, the likelihood of excess ZR8 particles agglomerating increases. This agglomeration may disrupt or even eliminate the interaction interface between the filler and polymer matrix. Additionally, the presence of excess ZR8 may lead to a reduction in the available free volume within the polymer, further hindering the movement of ions.

Excessive filler content in a CPE may impede ion transport, resulting in reduced ionic conductivity. The filler acts as a physical barrier that hinders ion diffusion and increases resistance, as well as disrupts the formation of an ion-conductive network within the CPEs.

### Example 15: Linear Sweep Voltammetry (LSV)

To assess the electrochemical operating-window of the ZR8-CPEs at 60° C., LSV measurements were conducted using a coin cell configuration of [SS|ZR8-CPE|Li] within the potential range of 3 to 6 V under a scan rate of 10 mV/s. SS herein denotes stainless steel.

During LSV, any oxidation or reduction reactions occurring within the measured voltage range can be detected by observing sharp changes in the current density: a rapid increase in current density is indicative of electrolyte breakdown at the electrode. Herein, in the LSV curve, a line is drawn tangential to the current density point of 0.12 milliamperes per centimeter square (mAcm⁻²)—which indicates decomposition—in order to show the decomposition potential. This allows for the evaluation of the electrochemically stable window of the ZR8-CPEs under the specified conditions.

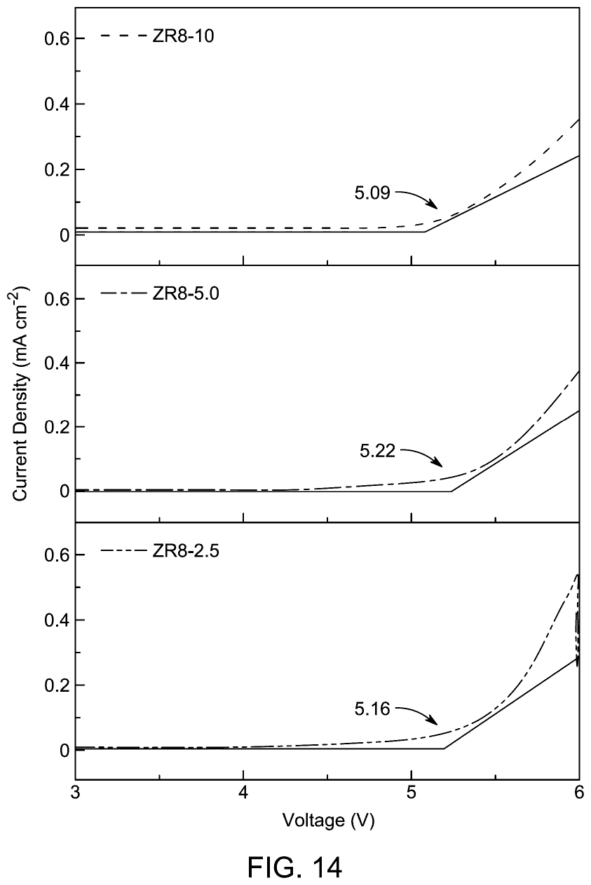

FIG. 14 presents LSV curves for the ZR8-2.5, ZRS-5.0, and ZR8-10 CPEs, respectively. The maximum operating potentials versus Li/Li⁺ established for the composite electrodes are provided in Table 8.

TABLE 8
Maximum operating potentials versus
Li/Li⁺ established for the composite electrodes.

| | Maximum Operating Potential |
|---|---|
| | versus Li/Li⁺; at 60° C. |
| Sample | (V) |
| CCPE | 4.10 |
| ZRS-2.5 | 5.16 |
| ZRS-5.0 | 5.22 |
| ZRS-7.5 | 5.58 |
| ZRS-10 | 5.09 |

The presence of ZR8 particles in the PEO-based electrolyte is revealed to be advantageous in enhancing the electrochemical stability of the solid-state electrolyte. The composite electrolytes may therefore represent promising candidates for applications requiring operation at high voltages.

### Example 16: Lithium-Ion Transference Number (t_{Li+})

The determination of the t_{Li+} is crucial in solid-state electrolytes (SSEs) as it offers valuable insights into the anion movement during charge-discharge cycling. This parameter plays a significant role in the polarization of the electrolyte throughout the cycling process.

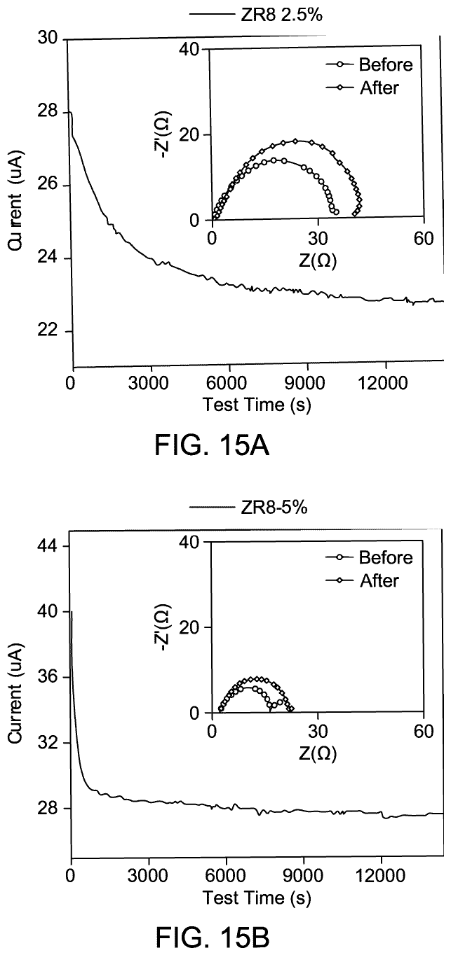

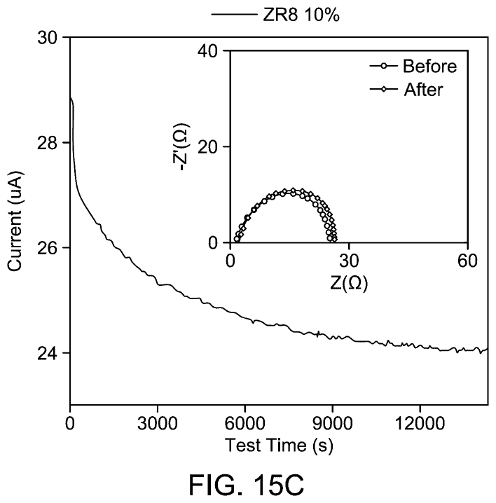

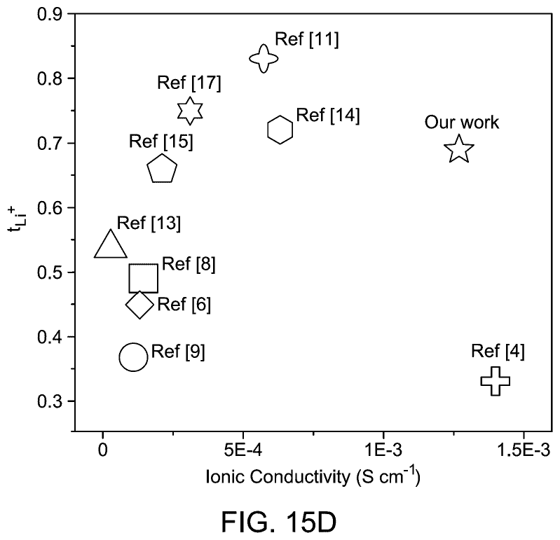

The t_{Li+} of ZR8-CPEs was determined through direct-current (DC) polarization and alternating-current (AC) EIS measurements, conducted both before and after polarization at 60° C. The current-time profiles of ZR8-CPEs can be observed in FIG. 15 appended hereto. FIG. 15A-15C shows current-time profile for ZR8-CPEs for various ZR8 content of (a) 2.5%, (b) 5%, and (c) 10% of coin cell [Li|ZR8-CPE|Li]@60° C. with polarization voltage of 10 mV for 14400 seconds: the inset of the Figures depicts the EIS before and after polarization.

The t_{Li+} of the ZR8-CPEs was evaluated herein using the Bruce-Vincent equation (Eq. 3):

$${t}_{Li} += \frac{{I}_{s} ( Δ V - {I}_{0} {R}_{0} )}{{I}_{0} ( Δ V - {I}_{s} {R}_{s} )} \qquad ( 3 )$$

wherein: I₀ denotes initial current; Iₛ denotes steady state current; ΔV is the applied DC Voltage; R₀ is the interphasial resistance measured at the initial state; and Rs is the interphasial resistance measured at the steady state. The parameters used for the calculation is shown in Table 9.

TABLE 9
The parameter used for the determination of
t_{Li+} for ZR8-CPEs at 60° C.

| | I₀ | Iₛ | R₀ | Rₛ | ΔV | |
|---|---|---|---|---|---|---|
| Sample | (μA) | (μA) | (Ω) | (Ω) | (V) | t_{Li+} |
| ZRS8-2.5 | 27.95 | 22.52 | 33.12 | 396.60 | 0.01 | 0.56 |
| ZRS8-5.0 | 40.02 | 27.46 | 144.21 | 201.63 | 0.01 | 0.65 |
| ZRS8-7.5 | 23.53 | 20.21 | 327.89 | 354.70 | 0.01 | 0.69 |
| ZRS8-10 | 28.91 | 23.61 | 239.54 | 248.91 | 0.01 | 0.61 |

It is noted that the obtained t_{Li+} value for ZR8-7.5 is 0.69, which is higher than those of the other ZR8-CPE samples. This higher transference number indicates the excellent electrochemical performance of ZR8-7.5, which may be attributable to the incorporation of ZR8 fillers in this amount serving to reduce the PEO crystallinity in the polymer matrix. The reduced crystallinity enhances the mobility of Li⁺ ions within the electrolyte, thereby improving the overall electrochemical performance. Further, the high surface area of ZR8 fillers may facilitate better contact with other components in the electrolyte. The controllable surface polarity of ZR8 allows for the adjustment of interactions between the Lewis acid sites and bases within the system. The combination of the rich Lewis acidic sites of Zr and the anion (TFSI⁻) may result in facilitated passage for Li⁺ transport, enabling efficient ion conductivity.

FIG. 15D shows a comparison of lithium-ion transference number and ionic conductivity at 60° C. with previously published articles [4, 8, 9, 11, 13-15, 17]. Such a comparison with previously published literature is also included in Table 10 hereinbelow, which table further includes prior published current density, stripping time and working temperature data.

TABLE 10

| | | | | | Li-ion | |
|---|---|---|---|---|---|---|
| | Ionic | Current | Stripping | Working | transference | |
| | Conductivity | Density | Time | Temperature | number | |
| Electrolyte | 10⁻⁴ S cm⁻¹ | (μA cm⁻²) | (hours) | (° C.) | (t_{Li}⁺) | Ref. |
| PEO- | 1.2 at 25° C.; | 0.05 | 1000 | 60 | 0.33 | 4 |
| LiTFSI- | 140 at 60° C. | | | | | |
| SiO₂/TDI | | | | | | |
| PEO- | 2.5 at 40° C.; | 0.1 | 800 | 50 | 0.22 | 5 |
| LiTFSI- | 10.1 at 80° C. | | | | | |
| SNWs | | | | | | |
| PEO- | 1.3 at 60° C. | 0.1 | 1000 | 60 | 0.45 | 6 |
| LiTFSI- | | | | | | |
| (Ca—CeO₂) | | | | | | |
| PEO- | 1.5 at 35° C. | 0.1 | 1500 | 55 | 0.49 | 7 |
| LiTFSI- | | | | | | |
| LLZO | | | | | | |
| PEO- | 1.1 at 30° C. | 0.1 | 400 | 90 | 0.37 | 8 |
| LiClO₄— | | | | | | |
| SiO₂ | | | | | | |
| PEO- | 1.1 at 30° C. | 0.1 | 400 | 55 | | 9 |
| LiClO₄— | | | | | | |
| SiO₂ | | | | | | |
| PEO- | 4.3 at 60° C. | 0.1 | 200 | 60 | | 10 |
| LiTFSI- | | | | | | |
| SBA-LiIL | | | | | | |
| PEO- | 5.7 at 30° C. | 0.1 | 1800 | 60 | 0.83 | 11 |
| LiTFSI- | | | | | | |
| MZLT | | | | | | |
| PEO- | 14.0 at 30° C. | 0.1 | 900 | 60 | | 12 |
| LiTFSI- | | | | | | |
| PTFE | | | | | | |
| PEG-PEI- | 0.30 at 30° C. | 0.1 | 1000 | 60 | 0.54 | 13 |
| LiTFSI-MOF | | | | | | |
| P@CMOF | 6.3 at 60° C. | 0.1 | 400 | 60 | 0.72 | 14 |
| PL10M | 2.3 at 30° C. | 0.1 | 1400 | 50 | 0.66 | 15 |
| SCE-MIL | 2.1 at 60° C. | 0.1 | 800 | 60 | 0.23 | 16 |
| CSPE- | 3.1 at 60° C. | 0.1 | 1800 | 60 | 0.75 | 17 |
| Ce-MOF | | | | | | |
| ZR8-7.5 | 13.5 | 0.1 | 8000 | 60 | 0.69 | This |
| | | | | | | work |

Key to Table 10:
TDI: 2,4-toluene diisocyanate; LiIL: Lithium ion ionic liquid; SNWs: SiO₂ nanowires; SBA = Mesoporous silica; SCE-MIL: MIL-100 (Fe) solid composite electrolyte; CSPE-MOF = Ce-based MOF solid polymer electrolyte; LLZO: Li₇La₃Zr₂O₁₂; LGPS: Li₁₀GeP₂S₁₂; MZLT: a hydrophobic surface-modified zeolite filler.
4. C. Li, Y. Huang, X. Feng, Z. Zhang, H. Gao and J. Huang, J. Colloid Interface Sci., 2021, 594, 1-8, the disclosure of which is herein incorporated by reference in its entirety.
5. J. Wu, J. Chen, X. Wang, A. Zhou and Z. Yang, Mater. Chem. Front., 2021, 5, 7767-7777, the disclosure of which is herein incorporated by reference in its entirety.
6. H. Chen, D. Adekoya, L. Hencz, J. Ma, S. Chen, C. Yan, H. Zhao, G. Cui and S. Zhang, Advanced Energy Materials, 2020, 10, the disclosure of which is herein incorporated by reference in its entirety.
7. Z. Guo, Y. Pang, S. Xia, F. Xu, J. Yang, L. Sun and S. Zheng, Adv. Sci, 2021, 8, 2100899, the disclosure of which is herein incorporated by reference in its entirety.
8. Z. Xu, T. Yang, X. Chu, H. Su, Z. Wang, N. Chen, B. Gu, H. Zhang, W. Deng, H. Zhang and W. Yang, Appl. Mater. Interfaces, 2020, 12, 10341-10349, the disclosure of which is herein incorporated by reference in its entirety.
9. X. Tan, Y. Wu, W. Tang, S. Song, J. Yao, Z. Wen, L. Lu, S. V. Savilov, N. Hu and J. Molenda, Nanomaterials, 2020, 10, 157, the disclosure of which is herein incorporated by reference in its entirety.
10. X. Shen, R. Li, H. Ma, L. Peng, B. Huang, P. Zhang and J. Zhao, Solid State Ion., 2020, 354, 115412, the disclosure of which is herein incorporated by reference in its entirety.
11. H. Jamal, F. Khan, H. Lim and J. H. Kim, SM&T, 2023, 35, e00548, the disclosure of which is herein incorporated by reference in its entirety
12. Q. Liang, L. Chen, J. Tang, X. Liu, J. Liu, M. Tang and Z. Wang, Energy Stor. Mater., 2023, 55, 847-856, the disclosure of which is herein incorporated by reference in its entirety.
13. W. Wen, Q. Zeng, P. Chen, X. Wen, Z. Li, Y. Liu, J. Guan, A. Chen, W. Liu and L. Zhang, Nano Res., 2022, 15, 8946-8954, the disclosure of which is herein incorporated by reference in its entirety.
14. H. Huo, B. Wu, T. Zhang, X. Zheng, L. Ge, T. Xu, X. Guo and X. Sun, Energy Storage Materials, 2019, 18, 59-67, the disclosure of which is herein incorporated by reference in its entirety.
15. D. Han, Z. Zhao, Z. Xu, H. Wang, Z. He, H. Wang, J. Shi and L. Zheng, ACS Appl. Energy Mater., 2022, 5, 8973-8981, the disclosure of which is herein incorporated by reference in its entirety.
16. T. Wei, Z. Wang, M. Zhang, Q. Zhang, J. Lu, Y. Zhou, C. Sun, Z. Yu, Y. Wang, M. Qiao and S. Qin, Mater. Today Commun., 2022, 31, 103518, the disclosure of which is herein incorporated by reference in its entirety
17. X. Wu, K. Chen, Z. Yao, J. Hu, M. Huang, J. Meng, S. Ma, T. Wu, Y. Cui and C. Li, J. Power Sources, 2021, 501, 229946, the disclosure of which is herein incorporated by reference in its entirety.

### Example 17: Measurement of Overpotential Values

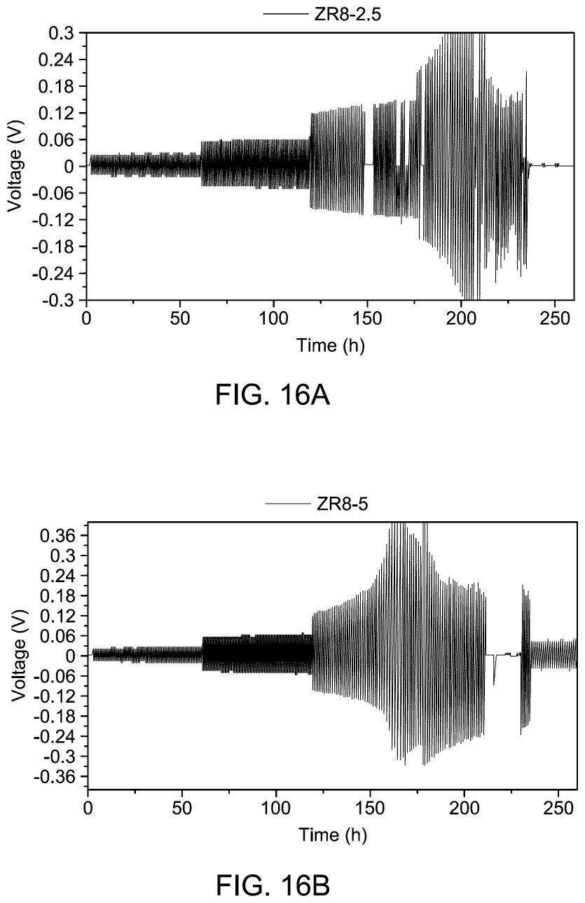

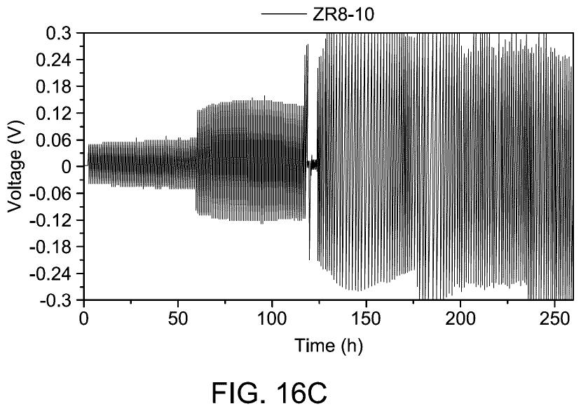

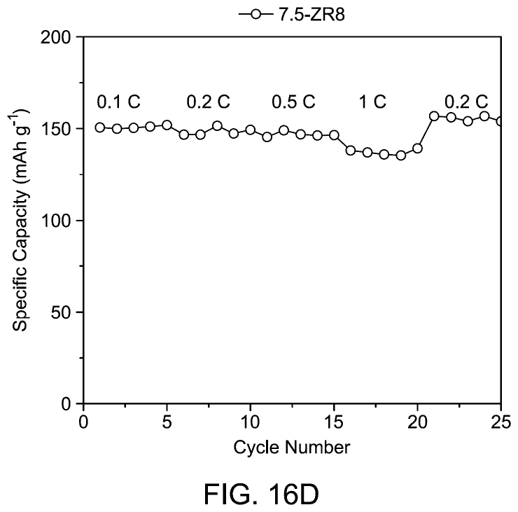

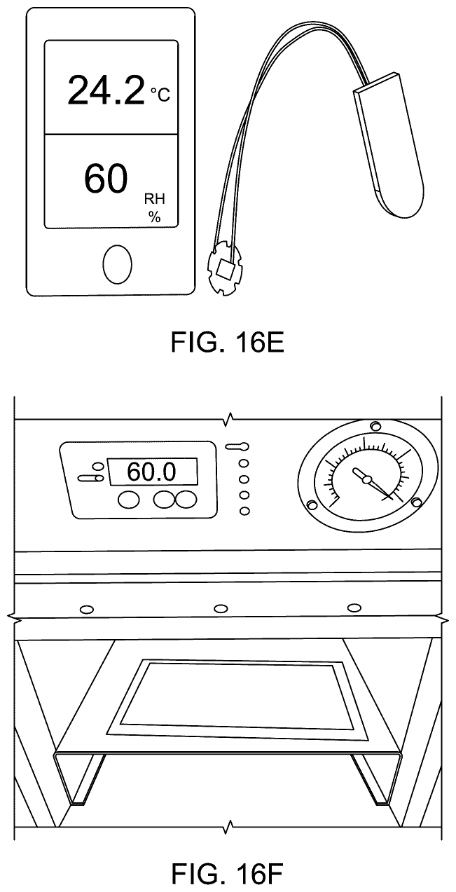

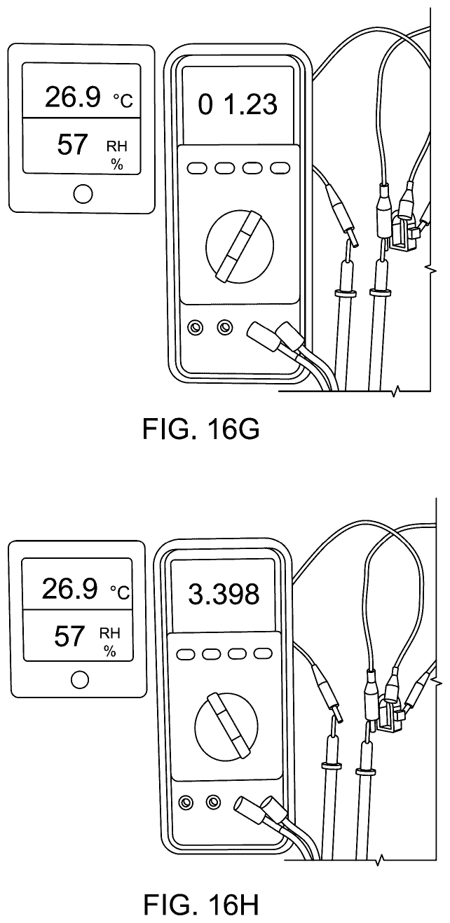

The performance of solid polymer electrolytes and ZR8-CPEs during lithium plating/stripping was evaluated using a coin cell configuration of [Li|ZR8-CPE|Li] to assess the interfacial compatibility of the electrolyte film with Li anodes. The lithium plating/stripping behavior was studied at various current densities from 50 to 300 μAcm⁻², and the overpotential values of ZR8-CPEs were recorded and provided in Table 11. FIG. 16A-16C shows electrochemical performance of Li-stripping cycling in the [Li|electrolyte|Li] at different current densities of from 50-300 Acm⁻² for 300 cycles at 60° C. for ZR8-2.5, ZR8-5, and ZR8-10, respectively.

TABLE 11
Overpotential values of ZR8-CPEs at various current
densities in lithium plating/stripping analysis.

| | Voltage (V) | | | | |
|---|---|---|---|---|---|
| | 50 | 100 | 200 | 300 | 300 μAcm⁻² |
| Sample | μAcm⁻² | μAcm⁻² | μAcm⁻² | μAcm⁻² | (234^{th} hour) |
| ZRS8-2.5 | 0.023 | 0.054 | 0.110 | 0.220 | 0.210 |
| ZRS8-5 | 0.019 | 0.052 | 0.127 | 0.387 | 0.167 |
| ZRS8-7.5 | 0.016 | 0.041 | 0.078 | 0.117 | 0.113 |
| ZRS8-10 | 0.047 | 0.125 | 0.273 | 0.269 | 0.428 |

In the symmetric lithium cells, the overpotential values for the ZR8-7.5 cell are 0.016, 0.041, 0.078, and 0.078 V at current densities of 50, 100, 200, and 300 μAcm⁻², respectively. These values indicate a lower overpotential compared to those of the other ZR8-CPE samples. Notably, at a high current density of 300 μAcm⁻² and after 234 hours of testing, ZR8-7.5 CPE exhibits a potential value of 0.113 V, which is lower than those of the other samples under the same conditions.

The lower overpotential observed in ZR8-7.5 CPE indicates its superior performance in lithium plating/stripping compared to the other ZR8-CPE samples. This finding suggests that ZR8-7.5 CPE exhibits enhanced interfacial compatibility with Li anodes, leading to more stable lithium plating and stripping processes. The electrochemical stability of the ZR8-7.5 CPE, when a constant current is applied, may be attributed to its composition, which facilitates better Li-ion transport and reduces the energy barrier for lithium plating and stripping reactions.

### Example 18: Rate Capability of the Electrolyte

The rate capability of the coin cells having the configuration [Li|ZR8-7.5|Li] and operated at 60° C. was evaluated at different charge rates (C-rates). The results thereof are provided in FIG. 16D appended hereto and in Table 12.

TABLE 12
Discharge capacity values of ZR8-CPEs
with LFP from 0.1-1 C at 60° C.

Voltage (mAhg⁻¹)

| Sample | 0.1 C | 0.2 C | 0.3 C | 1 C | 2 C |
|---|---|---|---|---|---|
| ZRS8-7.5 | 151.0 | 147.5 | 145.0 | 139.7 | 157.2 |

The results indicate that the cell maintains a stable discharge capacity throughout cycling at each C-rate. Specifically, the cells deliver discharge capacities of 151.0, 147.5, 145.0, 139.7, and 157.2 mAhg⁻¹ at 0.1, 0.2, 0.5, 1.0, and 0.2 C, respectively, over 10 cycles. When the current rate is returned to 0.2 C, the discharge capacity increases to 157.2 mAhg⁻¹. The initial decrease in capacity may be attributed to the formation of a solid electrolyte interphase (SEI) film on the electrode surface.

FIGS. 16E-16H appended hereto show respectively: the practical utility of a coin cell based on ZR8-7.5 CPE for lighting a LED at room temperature; the practical utility of a coin cell based on ZR8-7.5 electrolyte for lighting a LED at 60° C.; the picture of ZR8-CPE coin cell with multimeter during the measurement of current at room temperature; and, the picture of ZR8-CPE coin cell with multimeter during the measurement of voltage at room temperature.

### Example 19: Discharge Capacity Retention

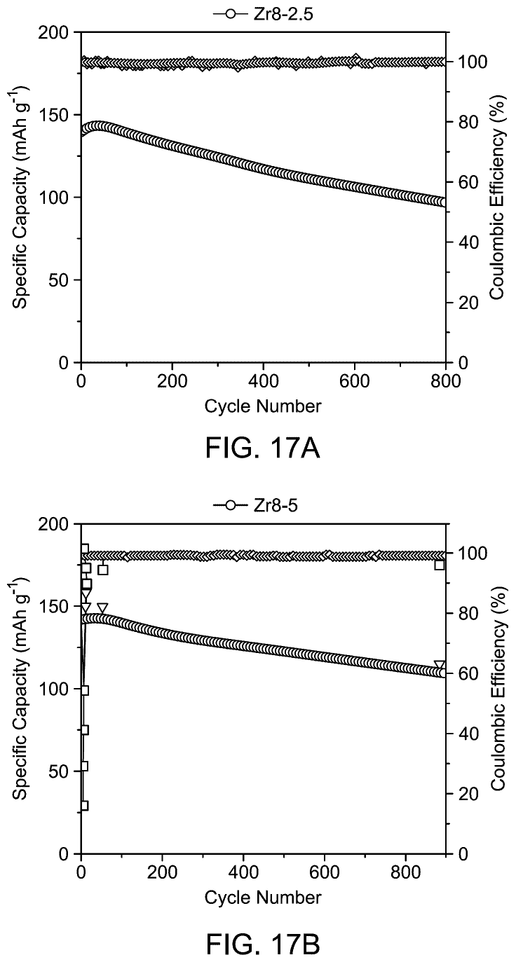

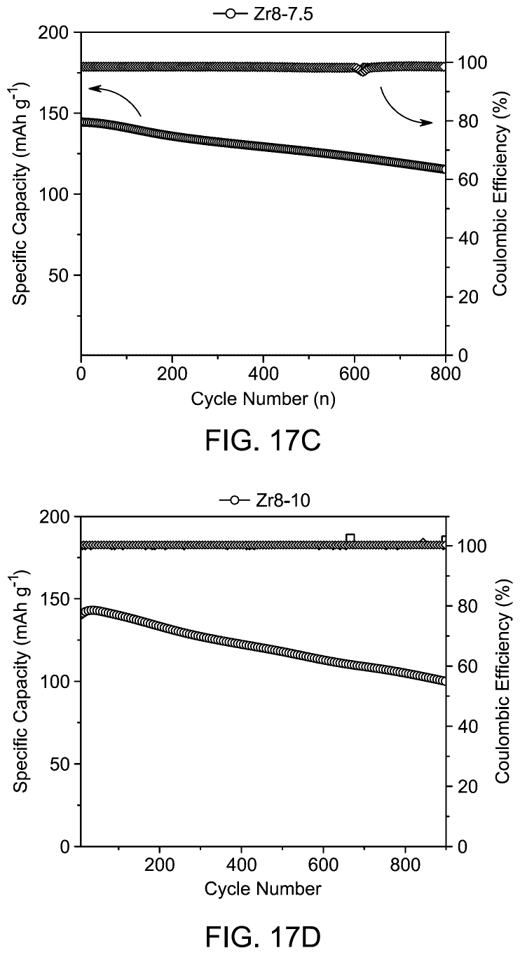

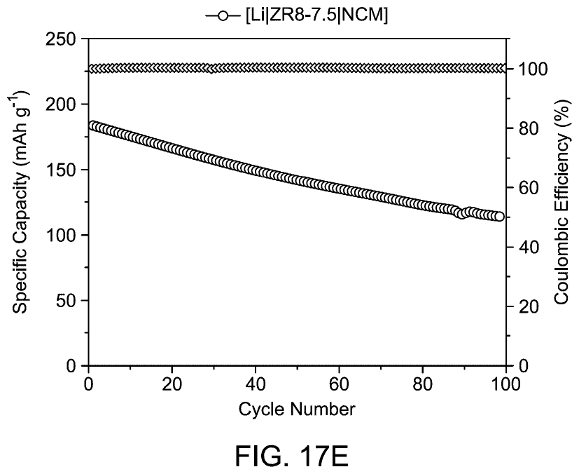

The cycling behaviors of fabricated solid polymer electrolyte films in asymmetrical [Li|ZR8-CPE|LFP] coin cell structures were examined by subjecting each cell to a 0.5 coulombs (C) discharge rate for 800 cycles: LFP refers to lithium iron phosphate FIGS. 17A-17D show cycling performance of ZR8-CPEs for 800 cycles at 0.5 C using coin cell [Li|ZR8CPE|LFP] at 60° C. for ZR8-2.5, ZR8-5, ZR8-7.5 and ZR8-10, respectively. The cycling performance results for the ZR8-CPEs are also provided in Table 13.

TABLE 13
First, last cycle discharge capacity, and capacity retention (%) with
LFP at charging rate of 0.2 C and discharge rate of 0.5 C at 60° C.

| | First | Maximum | Measured Capacity after nth | | | | Capacity |
|---|---|---|---|---|---|---|---|
| | Capacity | Capacity | Cycle (mAhg⁻¹) | | | | Retention |
| ZRS-CPE | (mAhg⁻¹) | (mAhg⁻¹) | 200^{th} | 400^{th} | 600^{th} | 800^{th} | (%) |
| ZR8-2.5 | 140.4 | 143.5 | | | | 97.6 | 71.4 |
| ZR8-5.0 | 142.2 | 143.0 | | | | 110.5 | 77.8 |
| ZR8-7.5 | 144.9 | 145.5 | 136.1 | 130.7 | 123.4 | 116.7 | 80.5 |
| ZR8-10 | 141.0 | 143.3 | | | | 99.6 | 70.6 |

Despite the decreasing trend in discharge capacity, the cells exhibit 100% coulombic efficiency. The ZR8-7.5 CPE yields the highest retention capacity of 80.53%, indicating the reversibility of the lithium-ion intercalation process and the electrochemical stability of the ZR8 MOF-based composite polymer electrolyte. This long cycling performance of the cell containing ZR8-7.5 CPE may be attributed to the high ionic conductivity and high surface area of this ZR8 MOFs, which facilitates the migration of Li⁺ ions from the electrolyte to the Li electrode. A higher ionic conductivity reflects greater ease of ion movement within the electrolyte, which facilitates smooth transport of lithium ions during charge and discharge cycles. This smooth transport promotes uniform ion distribution and minimizes the formation of concentration gradients within the battery. With its high ionic conductivity, the ZR8-7.5 CPE enables effective lithium-ion intercalation and deintercalation processes. The enhanced ion transport provided by the ZR8-7.5 CPE ensures long cycling stability. FIG. 17D shows cycling performance of ZR8-7.5 CPE for 100 cycles at 0.1 C using coin cell [Li|electrolyte|NCM811] at 60° C., wherein NCM811 denotes lithium nickel manganese cobalt oxide. This figure supports the long cycling stability which may be obtained for coin cells containing the ZR8-7.5 CPE.

### Example 20: Lithium Dendrite Growth

To evaluate the inhibition ability of the ZR8-2.5 and ZR8-7.5 composite polymer electrolytes on lithium dendrite growth, asymmetric [Li|ZR8-2.5|LFP] and [Li|ZR8-2.5|LFP] coin cells were cycled at 60° C. with a current density of 100 μAcm⁻² LFP refers to lithium iron phosphate. After 800 cycles, the cells were disassembled to examine the degradation of the components and the nature of Li-dendrite formation.

Scanning electron microscopy (SEM) was used to capture high-resolution images of the electrode surfaces, which provided valuable insights into their morphological characteristics. In the comparison of the SEM images of cells, the visual impact of the composite electrolyte on reduced Li-dendrite growth can be observed. This analysis serves to assess the effectiveness of ZR8-CPE in mitigating Li-dendrite formation and its potential for better cell performance and stability of Li-metal batteries.

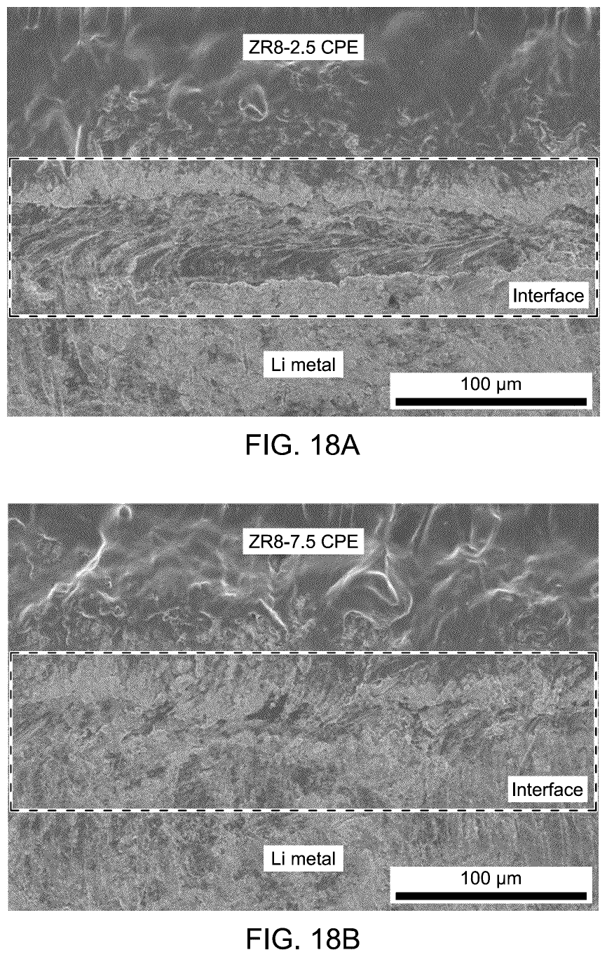

The SEM images of the Li-metal surface from the [Li|ZR8-CPE|LFP] coin cells are provided in FIG. 18A (CPE: ZRS-2.5) and FIG. 18B (CPE: ZRS: 7.5) appended hereto.

For the ZR8-2.5 CPE (FIG. 18A), a nonuniform surface morphology with several holes are observed. Normally, non-homogeneous and non-compact deposition of Li during the cycling process causes the growth of Li-dendrites, which also leads to the formation of random holes on the surface. Li-dendrites, which resemble needle-like structures, develop as a result of non-uniform Li-ion plating and deposition on the electrode surface. As these dendrites grow, they protrude outward, causing irregularities and deformations on the surface. These protrusions can penetrate the electrolyte layer, resulting in the formation of holes or voids on the SPE surface and creating potential risk of short circuits.

In contrast, the ZR8-7.5 CPE, illustrated in FIG. 18B appended hereto, presented a much smoother surface with a few holes which are naturally attributed to the presence of a higher amount of ZR8 in ZR8-7.5 CPE.

In both instances, the presence of ZR8 hindered Li-dendrite growth and improved stability, leading to a more continuous and reliable contact between the composite polymer electrolyte and the Li-metal electrode. These findings highlight that the presence of ZR8 in critical amounts with the CPEs can effectively control the growth of Li-dendrite and maintain a stable electrode-electrolyte interface. The ability to suppress dendritic growth is crucial for preventing short circuits and enhancing the overall safety and stability of LMBs.

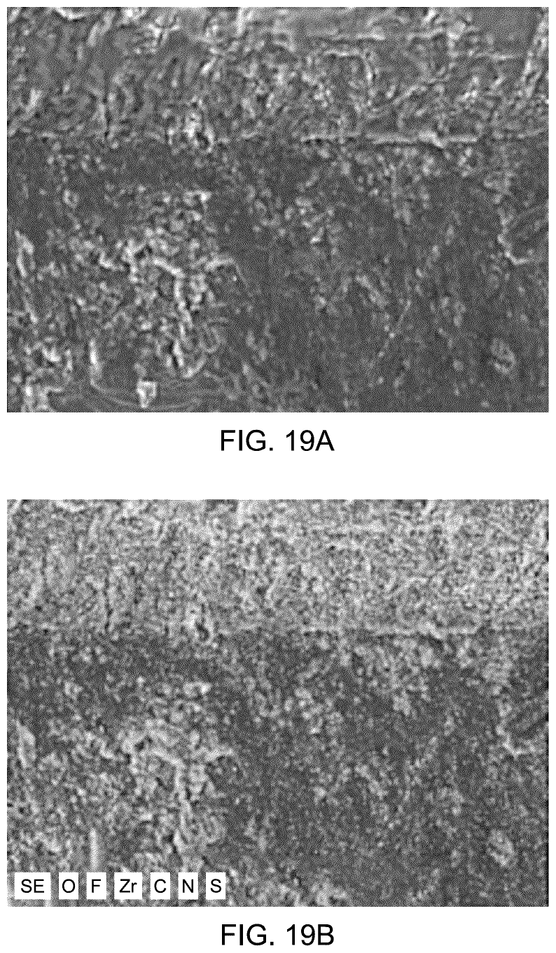

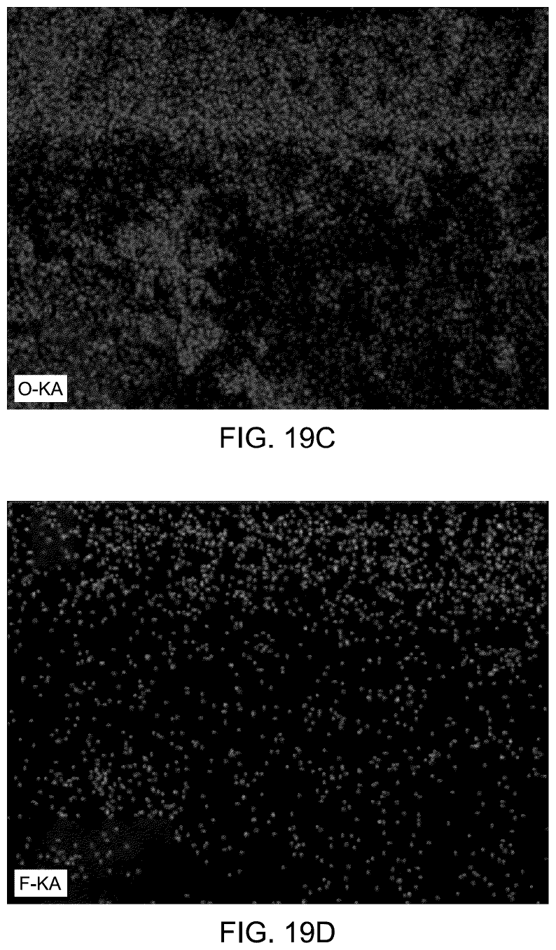

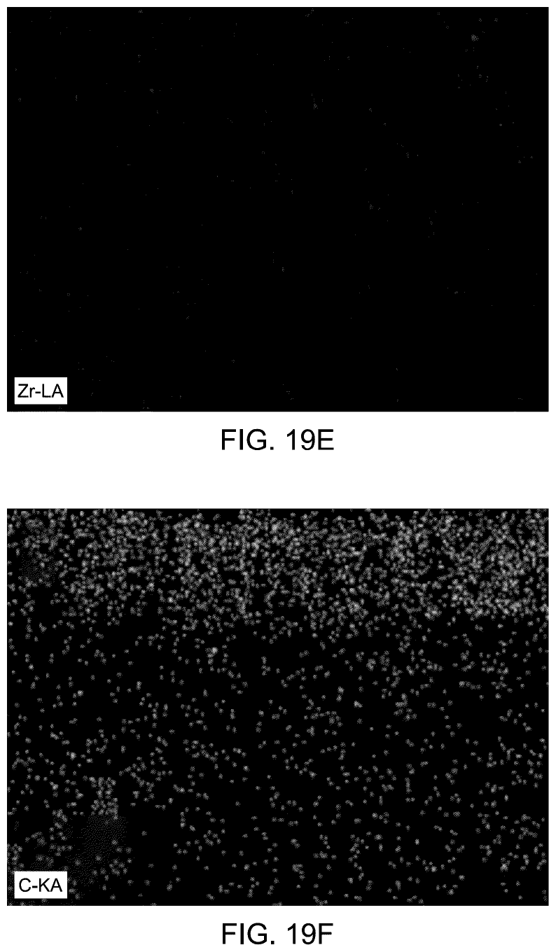

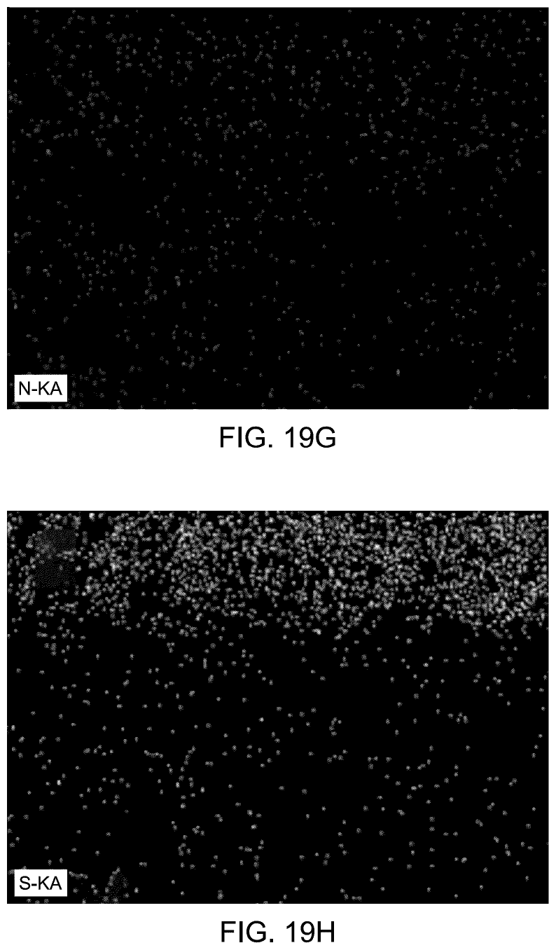

FIG. 19A-19H appended hereto provides the SEM-EDX elemental mapping of ZR8-7.5 after 800 cycles. FIG. 19A shows the SEM image of ZR8-7.5 after 800 cycles. FIG. 19B shows the EDX elemental map of ZR8-7.5 after 800 cycles. FIGS. 19C-19H show the EDX elemental mapping images of ZR8-7.5 after 800 cycles revealing the presence of O, F, Zr, C, N, and S, respectively. This mapping technique provides valuable information regarding the distribution of elements, including O, F, Zr, C, N, and S, within the ZR8-7.5 CPE system. The mapping clearly shows the formation of a well-defined interface between the electrolyte and the Li-metal. In the F elemental mapping, the concentration of F is higher on the electrolyte surface, indicating its presence in the electrolyte material. However, the concentration of F is lower on the surface of the Li-metal, suggesting a limited formation of dendrites, which are branching structures that can lead to short circuits and other safety issues in batteries. Similar observations are noticed for the other elements. This result further supports the notion that the formation of dendrites in the ZR8-7.5 CPE is minimal, as indicated by the lower concentrations of these elements in regions prone to dendrite growth. SEM-EDX elemental mapping provides evidence of a clear and well-defined interface within the ZR8-7.5 CPE after 800 cycles with LFP. The lower concentrations of elements associated with dendrite formation suggest that the ZR8-7.5 CPE effectively inhibits the growth of dendrites, reducing the risk of short circuits and enhancing the safety and stability of the battery system.

### Example 21: Fabrication of a Cathode

A composite cathode was synthesized by mixing active material, conductive carbon, binder and SPE. More specifically, Super P, carbon nanotubes, polyvinylidene fluoride (PVDF), LiTFSI and PEO were mixed at a ratio by weight of 75:8:1:4:3:9 respectively. The mixture was dispersed in N-methyl-2-pyrrolidone (NMP) and wet-milled using a high energy ball-milling machine. The uniformly mixed slurry was then cast on Al-foil by using doctor blade technique. After drying the composite cathode in a conventional oven at 90° C. for 2 hours, the partially dried composite was further dried in a vacuum oven at 70° C. for 12 hours. The loading mass of composite cathode was 2 mgcm⁻².

### Example 22: Comparative Assessment of Electrochemical Performance

Table 14 below details a comparison of the electrochemical performance of composite polymer electrolyte-based Li-metal solid-state batteries, both in accordance with the present disclosure and in accordance with previously published literature.

TABLE 14

| | | Working | Working | Specific | Retention | Loading | |
|---|---|---|---|---|---|---|---|
| | Cathode/ | Voltage | Temperature | Capacity | Rate | Weight | |
| Electrolyte | Anode | (V) | (° C.) | (mAhg⁻¹) | (%) | (mg cm⁻²) | Ref. |
| PEO- | LiFPO₄/Li | 2.7-3.8 | 60 | 150 | 83.7 (200) | | 4 |
| LiTFSI- | | | | | 0.2 C | | |
| SiO₂/TDI | | | | | | | |
| PEO- | LiFPO₄/Li | 2.8-4.2 | 60 | 151 | 83.4 (100) | 3.8 | 18 |
| LiTFSI- | | | | | 0.1 C | | |
| SNts | | | | | | | |
| PEO- | LiFPO₄/Li | 2.4-4.0 | 50 | 122 | 89.3 (50) | 1.6 | 5 |
| LiTFSI- | | | | | 0.5 C | | |
| SNWs | | | | | | | |
| PEO- | LiFPO₄/Li | 2.5-4.0 | 60 | 125 | 74.4 (200) | | 6 |
| LiTFSI | | | | | 1.0 C | | |
| (Ca—CeO₂) | | | | | | | |
| PEO- | LiFPO₄/Li | 2.5-3.8 | 60 | 145 | 92.0 (300) | 4.0 | 19 |
| LiTFSI- | | | | | 0.5 C | | |
| LAGP | | | | | | | |
| PEO- | LiFPO₄/Li | 2.8-3.8 | 55 | 155 | 84.0 (450) | | 7 |
| LiTFSI- | | | | | 0.2 C | | |
| LLZO | | | | | | | |
| PEO- | LiFPO₄/Li | 2.8-4.3 | 50 | 130 | 80.7 (400) | | 20 |
| LiTFSI- | | | | | 0.3 C | | |
| Li₂S₆ | | | | | | | |
| PEO- | LiFPO₄/Li | 2.6-4.0 | 60 | 156 | 95.0 (100) | 2.2-2.5 | 21 |
| LiTFSI- | | | | | 0.1 C | | |
| ZYNa | | | | | | | |
| PEP- | LiFPO₄/Li | 2.5-4.3 | 90 | 88 | 62.8 | 7.0 | 8 |
| LiClO₄— | | | | | (10-100) | | |
| SiO₂ | | | | | 0.2 C | | |
| PEO-PEO- | LiFPO₄/Li | 2.5-4.1 | 90 | 130 | 78.5 (65) | 1.0 | 22 |
| LiClO₄— | | | | | 1 C | | |
| MUSiO₂ | | | | | | | |
| PEO- | LiFPO₄/Li | 2.7-3.9 | 60 | 140 | 67.8 (90) | 1.0 | 9 |
| LiClO₄— | | | | | 0.2 C | | |
| SiO₂ | | | | | | | |
| PEO- | LiFPO₄/Li | 2.7-3.9 | 60 | 140 | 57.1 (50) | 1.2-1.5 | 23 |
| LiTFSI- | | | | | 0.5 C | | |
| SiO₂/Li₂SO₄ | | | | | | | |
| PEO- | LiFPO₄/Li | | 60 | 140 | 85.7 (80) | | 10 |
| LiTFSI- | | | | | 0.1 C | | |
| SBA-LiIL | | | | | | | |
| PEO- | LiFPO₄/Li | 2.8-4.2 | 60 | 160 | 97.4 (70) | 1.7 | 24 |
| LiTFSI- | | | | | 0.5 C | | |
| LLZO | | | | | | | |
| PEO- | LiFPO₄/Li | 2.5-4.0 | 60 | 158 | 91.0 (150) | | 25 |
| LiTFSI- | | | | | 0.5 C | | |
| LGPS | | | | | | | |
| PEO- | LiFPO₄/Li | 2.5-3.7 | 35 | 130 | 82.0 (200) | 0.8 | 26 |
| LiTFSI- | | | | | 0.5 C | | |
| VAVS | | | | | | | |
| PEO- | LiFPO₄/Li | 2.6-4.0 | 60 | 119 | 98.5 (200) | 2.5 | 11 |
| LiTFSI- | | | | | 0.5 C | | |
| MZLT | | | | | | | |
| PEO- | LiFPO₄/Li | 2.6-4.0 | 60 | 145 | 80.5 (800) | 2.0 | This |
| LiTFSI- | | | | | 0.5 C | | work |
| R8-7.5 | | | | | | | |

Key to Table 14:
TDI: 2,4-toluene diisocyanate; LiIL: Lithium ion ionic liquid; SNWs: SiO₂ nanowires; SNts: one-dimensional silica nanotubes; SBA: Mesoporous silica; SCE-MIL: MIL-100 (Fe) solid composite electrolyte; CSPE-MOF: Ce-based MOF solid polymer electrolyte; LLZO: Li₇La₃Zr₂O₁₂; LGPS: Li₁₀GeP₂S₁₂; MZLT: a hydrophobic surface-modified zeolite filler; MUSiO2: Monodispersed ultrafine SiO2 nanospheres.
4. C. Li, Y. Huang, X. Feng, Z. Zhang, H. Gao and J. Huang, J. Colloid Interface Sci., 2021, 594, 1-8, the disclosure of which is herein incorporated by reference in its entirety.
5. J. Wu, J. Chen, X. Wang, A. Zhou and Z. Yang, Mater. Chem. Front., 2021, 5, 7767-7777, the disclosure of which is herein incorporated by reference in its entirety.
6. H. Chen, D. Adekoya, L. Hencz, J. Ma, S. Chen, C. Yan, H. Zhao, G. Cui and S. Zhang, Advanced Energy Materials, 2020, 10, the disclosure of which is herein incorporated by reference in its entirety.
7. Z. Guo, Y. Pang, S. Xia, F. Xu, J. Yang, L. Sun and S. Zheng, Adv. Sci, 2021, 8, 2100899, the disclosure of which is herein incorporated by reference in its entirety.
8. Z. Xu, T. Yang, X. Chu, H. Su, Z. Wang, N. Chen, B. Gu, H. Zhang, W. Deng, H. Zhang and W. Yang, Appl. Mater. Interfaces, 2020, 12, 10341-10349, the disclosure of which is herein incorporated by reference in its entirety.
9. X. Tan, Y. Wu, W. Tang, S. Song, J. Yao, Z. Wen, L. Lu, S. V. Savilov, N. Hu and J. Molenda, Nanomaterials, 2020, 10, 157, the disclosure of which is herein incorporated by reference in its entirety.
10. X. Shen, R. Li, H. Ma, L. Peng, B. Huang, P. Zhang and J. Zhao, Solid State Ion., 2020, 354, 115412, the disclosure of which is herein incorporated by reference in its entirety.
11. H. Jamal, F. Khan, H. Lim and J. H. Kim, SM&T, 2023, 35, e00548, the disclosure of which is herein incorporated by reference in its entirety.
18. J. Hu, W. Wang, X. Zhu, S. Liu, Y. Wang, Y. Xu, S. Zhou, X. He and Z. Xue, J. Membr. Sci, 2021, 618, 118697, the disclosure of which is herein incorporated by reference in its entirety.
19. A. Li, X. Liao, H. Zhang, L. Shi, P. Wang, Q. Cheng, J. Borovilas, Z. Li, W. Huang, Z. Fu, M. Dontigny, K. Zaghib, K. Myers, X. Chuan, X. Chen and Y. Yang, Adv Mater, 2020, 32, 1905517, the disclosure of which is herein incorporated by reference in its entirety.
20. R. Fang, B. Xu, N. S. Grundish, Y. Xia, Y. Li, C. Lu, Y. Liu, N. Wu and J. B. Goodenough, Angew. Chem. Int. Ed., 2021, 60, 17701-17706, the disclosure of which is herein incorporated by reference in its entirety.
21. H. Jamal, F. Khan, H. -R. Si and J. H. Kim, J. Mater. Chem. A, 2021, 9, 27304-27319, the disclosure of which is herein incorporated by reference in its entirety.
22. D. Lin, W. Liu, Y. Liu, H. R. Lee, P. -C. Hsu, K. Liu and Y. Cui, Nano Letters, 2016, 16, 459-465, the disclosure of which is herein incorporated by reference in its entirety
23. J. Yu, C. Wang, S. Li, N. Liu, J. Zhu and Z. Lu, Small, 2019, 15, 1902729, the disclosure of which is herein incorporated by reference in its entirety.
24. Z. Wan, D. Lei, W. Yang, C. Liu, K. Shi, X. Hao, L. Shen, W. Lv, B. Li, Q. -H. Yang, F. Kang and Y. -B. He, Adv. Funct. Mater., 2019, 29, 1805301, the disclosure of which is herein incorporated by reference in its entirety.
25. K. Pan, L. Zhang, W. Qian, X. Wu, K. Dong, H. Zhang and S. Zhang, Adv Mater, 2020, 32, 2000399, the disclosure of which is herein incorporated by reference in its entirety.
26. W. Tang, S. Tang, X. Guan, X. Zhang, Q. Xiang and J. Luo, Adv. Funct. Mater., 2019, 29, 1900648, the disclosure of which is herein incorporated by reference in its entirety.

To conclude, a composite electrolyte was obtained by dispersing ZR8-CPEs and Li-salt into PEO matrix. Incorporation of ZR8 MOF was able to reduce the crystallization ratio of the PEO matrix and improved the ionic conductivity. The CPEs also showed improved mechanical properties with fire-retardant capability. In addition, the incorporation of ZR8 inhibited Li dendrite formation, facilitated the dissociation of Li-salt, and, where applicable, helped in limiting the movement of TFSI⁻ within the electrolyte. The optimized ZR8-CPE electrolyte (ZR8-7.5) showed high values of σ(2.30×10⁻⁴ and 1.27×10⁻³ S cm⁻¹ at 30° C. and 60° C., respectively). The fabricated [Li|ZR8-7.5|LFP] battery cell exhibited excellent stability, operating for 8000 hours without short-circuiting and with minimal over-potential. Moreover, the charge transfer resistance decreased during cycling. The cell showed good cycling stability with retention exceeding 80% of its initial performance after 800 cycles at 0.5 C discharge capacity. Finally, the solid electrolyte interphase (SEI) was investigated using SEM, and SEM-EDX. The study findings demonstrate the potential of ZR8-based polymer electrolytes in solid-state LMBs and provide valuable insights for selecting MOFs for modifying all-solid electrolytes.

Numerous modifications and variations of the present disclosure are possible in light of the above teachings. It is therefore to be understood that within the scope of the appended claims, the invention may be practiced otherwise than as specifically described herein.

1. A solid-state polymer electrolyte comprising, based on the weight of the electrolyte:
from 60 to 75 wt. % of polyethylene oxide (PEO), wherein the PEO is in the solid-state;
from 20 to 30 wt. % of a lithium salt (Li⁺X⁻); and,
from 1 to 20 wt. % of a zirconium (IV) benzene-1,3,5-tricarboxylate (BTC) metal-organic framework (MOF) having the X-ray diffraction (XRD) pattern of MOF-808 and having the general formula Zr₆O₄(OH)₄(BTC)(L)₆, wherein L is a counter-anion.

2. The solid-state polymer electrolyte according to claim 1 having:
an enthalpy of melting (ΔHₘ) of less than about 50 Jg⁻¹; and,
an ionic conductivity of at least about 30 microsiemens per centimeter (Scm⁻¹), as determined by electrochemical impedance spectroscopy at about 20° C.

3. The solid-state polymer electrolyte according to claim 1, wherein the PEO has a weight average molecular weight (Mw) of from about 100 to about 5000 kilodaltons (kDa).

4. The solid-state polymer electrolyte according to claim 1, wherein the molar ratio of the residues of EO in the PEO to Li⁺ is from about 15:1 to about 20:1.

5. The solid-state polymer electrolyte according to claim 1, wherein the lithium salt is selected from the group consisting of: lithium p-toluenesulfonate; lithium methanesulfonate; lithium trifluoromethane sulfonate; lithium bis(fluorosulfonyl)imide; and, lithium bis(trifluoromethylsulfonyl)imide (LiTFSI).

6. The solid-state polymer electrolyte according to claim 1, wherein the Zr (IV) BTC MOF is present in an amount of from about 2 to about 10 wt. %, based on the weight of the electrolyte.

7. The solid-state polymer electrolyte according to claim 1, wherein the Zr (IV) BTC MOF is present in an amount of from about 5 to about 10 wt. %, based on the weight of the electrolyte.

8. The solid-state polymer electrolyte according to claim 1, wherein the Zr (IV) BTC MOF is present in an amount of about 7.5 wt. %, based on the weight of the electrolyte.

9. The solid-state polymer electrolyte according to claim 1, wherein L is selected from the group consisting of fluoride, formate (COO⁻), acetate (CH₃COO⁻), propionate (CH₃CH₂COO⁻) and benzoate (C₆H₅COO⁻).

10. The solid-state polymer electrolyte according to claim 1, wherein L is acetate.

11. The solid-state polymer electrolyte according to claim 1 having a Li⁺ ion transference number (t_{Li+}) of at least about 0.5, as determined by direct current polarization at about 60° C. and alternating current Electrochemical Impedance Spectroscopy.

12. A method of making the solid-state polymer electrolyte as defined in claim 1, comprising:
drying the PEO in a vacuum oven at a first temperature for a first duration;
drying the lithium salt (Li⁺X⁻) and the Zr (IV) BTC MOF in a vacuum oven at a second temperature for a second duration;
mixing the dried lithium salt and the dried Zr (IV) BTC MOF in a first polar organic solvent to obtain a first mixture;
mixing the dried PEO with the first mixture to obtain a second mixture;
grinding the second mixture to obtain a first slurry; and,
evaporating the first polar organic solvent to obtain the solid-state polymer electrolyte.

13. The method according to claim 12, wherein:
the first temperature is from about 40 to about 80° C.;
the first duration is from about 6 to about 12 hours;
the second temperature is from about 100 to about 140° C.; and,
the second duration is from about 8 to about 16 hours.

14. The method according to claim 12, wherein the first polar organic solvent comprises at least one compound selected from the group consisting of dimethylformamide, diethylformamide, acetonitrile, methanol, ethanol, isopropanol, 1-butanol and acetone.

15. The method according to claim 12, further comprising:
dispersing the solid-state polymer electrolyte, at least one active material capable of insertion and extraction of Li⁺ ions, a conductive carbon additive and a binder in a second polar organic solvent to obtain a third mixture;
grinding the third mixture to obtain a second slurry;
casting the second slurry onto an aluminium foil to obtain a casted slurry;
drying the casted slurry in a conventional oven at a third temperature for a third duration to obtain a dried slurry; and;
vacuum drying the dried slurry at a fourth temperature for a fourth duration to obtain a composite electrode.

16. The method according to claim 15, wherein:
the at least one active material capable of insertion and extraction of Li⁺ ions is selected from the group consisting of lithium cobalt oxide (LiCoO₂), lithium manganese oxide (LiMn₂O₄), lithium iron phosphate (LiFePO₄) and lithium nickel manganese cobalt oxide (NMC); and,
the conductive carbon additive is selected from the group consisting of carbon black, carbon fibers, carbon nanotubes, carbon nanostructures (CNS), graphene, fullerene, graphite, activated carbon and mixtures thereof.

17. The method according to claim 15, wherein:
the at least one active material capable of insertion and extraction of Li⁺ ions comprises lithium iron phosphate (LiFePO₄); and,
the conductive carbon additive comprises carbon black and carbon nanotubes.

18. The method according to claim 15, wherein:
the third temperature is from about 200 to about 350° C.;
the third duration is from about 0.5 to about 12 hours;
the fourth temperature is from about 200 to about 350° C.; and,
the fourth duration is from about 0.5 to 12 hours.

19. An all-solid-state lithium metal battery comprising:
an anode comprising lithium and being capable of insertion and extraction of Li⁺ ions;
a cathode capable of insertion and extraction of Li⁺ ions; and,
a solid-state electrolyte disposed between the anode and cathode and comprising the solid-state polymer electrolyte as defined in claim 1,
wherein the all-solid-state lithium metal battery is fabricated in a coin-cell structure.

20. The battery according to claim 19, wherein the cathode comprises at least one composite lithium metal oxide selected from the group consisting of LiCoO₂, LiMn₂O₄, LiFePO₄, and NMC.
